(19) United States
(12) Patent Application Publication
(10) Pub. No.: US 2026/0010084 A1
(43) Pub. Date: Jan. 8, 2026

(54) TONER, TONER SET, IMAGE TRANSFER SHEET, TONER STORAGE UNIT, IMAGE FORMING APPARATUS, AND IMAGE FORMING METHOD

(71) Applicants: Toyoshi SAWADA, Kanagawa (JP); Kazumi SUZUKI, Kanagawa (JP); Katsunori KUROSE, Kanagawa (JP)

(72) Inventors: Toyoshi SAWADA, Kanagawa (JP); Kazumi SUZUKI, Kanagawa (JP); Katsunori KUROSE, Kanagawa (JP)

(21) Appl. No.: 19/251,811

(22) Filed: Jun. 27, 2025

(30) Foreign Application Priority Data
Jul. 2, 2024 (JP) 2024-106918
Feb. 26, 2025 (JP) 2025-028515

(51) Int. Cl. G03G 9/08; G03G 15/00; G03G 15/16

(52) U.S. Cl. CPC G03G 9/0819; G03G 15/1625; G03G 15/6591; G03G 2215/0604

(57) ABSTRACT

A toner is provided that includes toner base particles comprising a polyurethane resin in an amount of 50% by mass or more and 80% by mass or less of the toner base particles. The toner has a glass transition temperature Tg1 of less than 0° C., and each particle of the toner has a sea-island structure in a cross-sectional image obtained by a scanning electron microscope of the particle.

### CROSS-REFERENCE TO RELATED APPLICATIONS

This patent application is based on and claims priority pursuant to 35 U.S.C. § 119 (a) to Japanese Patent Application Nos. 2024-106918 and 2025-028515, filed on Jul. 2, 2024 and Feb. 26, 2025, respectively, in the Japan Patent Office, the entire disclosure of each of which is hereby incorporated by reference herein.

### BACKGROUND

### Technical Field

The present disclosure relates to a toner, a toner set, an image transfer sheet, a toner storage unit, an image forming apparatus, and an image forming method.

### Related Art

In an electrophotographic method in which an electrostatic latent image is developed by using a developer to form a visible image, an electrostatic latent image is formed on an electrostatic latent image bearer containing a photoconductive material, the electrostatic latent image is developed by using a developer containing a toner to form a toner image, and after the toner image is transferred onto a transfer material such as paper, the toner image is fixed by applying heat and pressure to form a fixed image.

To form a full-color image by the electrophotographic method, a toner set is generally used in which a black toner is combined with toners of three process colors, that is, cyan, magenta, and yellow.

In recent years, as a color image forming apparatus employing the electrophotographic method is widely used, the application of a printed matter generated by the color image forming apparatus is also more diverse. Particularly in the field of custom-made design consumer goods and the like, there is a growing need for printing by the electrophotographic method on a material on which an object cannot be printed because a known electrophotographic toner for printing on a paper medium cannot be fixed. Specifically, there is an increasing need for printing on cloth fabric media such as a uniform, shoes, and a bag of sports teams.

### SUMMARY

One embodiment of the present disclosure provides a toner including toner base particles comprising a polyurethane resin in an amount of 50% by mass or more and 80% by mass or less of the toner base particles. The toner has a glass transition temperature Tg1 of less than 0° C., and each particle of the toner has a sea-island structure in a cross-sectional image obtained by a scanning electron microscope of the particle.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an image forming apparatus;

FIG. 2 is a schematic diagram illustrating a configuration of a main part of an image forming apparatus;

FIG. 3 is a schematic diagram illustrating a configuration of a main part of an image forming apparatus; and

FIG. 4 is a cross-sectional image of a particle of a coarsely-pulverized melt-kneaded product of toner components of a toner, obtained by a scanning electron microscope (SEM).

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

According to embodiments of the present disclosure, a toner is provided that has an excellent fixability to a medium formed of flexible fibers such as a cloth and also a sufficient flexibility.

Typically, a cloth is flexible and often formed of fibers. In printing an image with a toner on such a flexible fiber medium, characteristics not provided in a known toner for a paper medium are demanded such as the toner sufficiently fixing to a cloth fiber or the like with considerable unevenness, and the fixed toner layer having an appropriate flexibility for deformation of the toner layer to follow unevenness or deformation of the cloth or the like.

As a result of extensive research, the inventors have found that use of a toner having a specific polyurethane content, structure, and glass transition temperature significantly improves the fixability of the toner to a medium formed of flexible fibers such as a cloth, and also imparts appropriate flexibility to the fixed toner layer.

That is, one embodiment of the present disclosure provides a toner including toner base particles comprising a polyurethane resin in an amount of 50% by mass or more and 80% by mass or less of the toner base particles. The toner has a glass transition temperature Tg1 of less than 0° C., and each particle of the toner has a sea-island structure in a cross-sectional image obtained by a scanning electron microscope of the particle.

A toner according to an embodiment of the present disclosure has an excellent fixability to a medium formed of flexible fibers such as a cloth and also a sufficient flexibility.

Embodiments of the present disclosure will be described below in detail.

### (Toner)

The toner according to an embodiment of the present disclosure is a toner including toner base particles comprising a polyurethane resin in an amount of 50% by mass or more and 80% by mass or less of the toner base particles. The toner has a glass transition temperature Tg1 of less than 0° C., and each particle of the toner has a sea-island structure in a cross-sectional image obtained by a scanning electron microscope of the particle.

Such a toner has a heat-resistant storage stability while having an excellent electrostatic charge ability, exhibits rubber elasticity at room temperature, and can prevent tensile cracking of a toner image formed on a flexible medium. Thus, a toner is provided having an excellent fixability to a medium formed of flexible fibers such as a cloth, and also a sufficient flexibility.

### <Glass Transition Temperature Tg1 of Toner>

The toner has a glass transition temperature Tg1 of less than 0° C. When the glass transition temperature Tg1 is 0° C. or higher, a toner image fixed on a medium formed of flexible fibers such as a cloth will not expand or contract easily and will be prone to cracking.

The glass transition temperature Tg1 of the toner can be measured, for example, by using a DSC system (differential scanning calorimeter) (“Q-200”, manufactured by TA Instruments). Specifically, for example, the glass transition temperature Tg1 can be measured according to the following procedure. First, about 5.0 mg of a toner being a sample to be tested is charged into a sample container formed of aluminum, and the sample container is placed on a holder unit and set in an electric furnace. Next, in a nitrogen atmosphere, the sample container is heated from −50° C. to 150° C. at a temperature increase rate of 10° C./min (first temperature increase). During the temperature increase, a DSC curve is measured by using a differential scanning calorimeter (“Q-200”, manufactured by TA Instruments). From the obtained DSC curves, the DSC curve during the temperature increase can be selected by using the analysis program in the Q-200 system, to determine the glass transition temperature according to the tangent method of the toner being a sample to be tested at the temperature increase. The glass transition temperature according to the tangent method thus determined is the glass transition temperature Tg1 of the toner being a sample to be tested.

### <Volume Average Particle Diameter of Toner>

A volume average particle diameter of the toner is not particularly limited and may be appropriately selected depending on the intended purpose, but is preferably 10 μm or more and 50 μm or less, and more preferably 10 μm or more and 30 μm or less. When the volume average particle diameter is 10 μm or more, the pile height of the toner layer can be increased, with which the unevenness of the surface of a flexible medium such as a cloth can be easily filled, and thus, an excellent concealability is achieved. In consideration of the trade-off with transferability, the volume average particle diameter is preferably 50 μm or less, and more preferably 30 μm or less.

### —Method of Measuring Volume Average Particle Diameter of Toner—

The volume average particle diameter of the toner can be measured, for example, by using a laser diffraction particle size distribution measurement device (“SALD-2300”, manufactured by Shimadzu Corporation). An example is described below.

First, 0.5 ml of a 10% by mass surfactant (alkylbenzene sulfonate, NEOGEN SC-A, manufactured by Daiichi Kogyo Seiyaku Co., Ltd.) is added to a 100 ml glass beaker, 2 to 4 g of the toner is added and stirred with a microspatula, and then 80 ml of ion-exchanged water is added to obtain a dispersion liquid. The resulting dispersion liquid is subjected to dispersion treatment for 10 minutes using an ultrasonic disperser (W-113MK-II, manufactured by Honda Electronics Co., Ltd.) to obtain a toner sample dispersion liquid. Using such toner sample dispersion liquid, the volume average particle diameter of the toner is measured using a laser diffraction particle size distribution measurement device (“SALD-2300”, manufactured by Shimadzu Corporation).

### <Polyurethane Resin>

The toner includes a polyurethane resin. The polyurethane resin is a binder resin and has an excellent tensile strength, tension resistance, abrasion resistance, elasticity, and oil resistance. The toner includes toner base particles that contain a polyurethane resin in an amount of 50% by mass or more of the toner base particles, and is excellent in tensile strength, tensile strength, abrasion resistance, elasticity, and oil resistance.

The content of the polyurethane resin in the toner base particles is 50% by mass or more and 80% by mass or less, preferably 55% by mass or more and 80% by mass or less, and more preferably 60% by mass or more and 80% by mass or less. When the content of the polyurethane resin in the toner base particles is less than 50% by mass, the toner fixes sufficiently to a flexible medium such as a cloth with difficulty, and the toner layer after fixing to the recording medium provides flexibility with difficulty. Further, when the content of the polyurethane resin in the toner base particles exceeds 80% by mass, the thermal storage stability of the toner is likely to deteriorate, and aggregation of the toner particles may occur.

The polyurethane resin contained in the toner is preferably a polyaddition reaction product of an aliphatic diol and a compound having an isocyanate group. When the polyurethane resin is a polyaddition reaction product of an aliphatic diol and a compound having an isocyanate group, the flexibility of the toner layer after fixing can be easily ensured. A method for producing the polyurethane resin contained in the toner is not particularly limited, and bulk polymerization, solution polymerization, emulsion polymerization, suspension polymerization or the like may be employed.

### —Aliphatic Diol—

Examples of the aliphatic diol include, but are not limited to, 1,4-butanediol and 1,6-hexanediol.

### —Compound Having Isocyanate Group—

An example of a compound having an isocyanate group includes, but is not limited to, diphenylmethane diisocyanate.

The polyurethane resin contained in the toner is more preferably a polyaddition reaction product of an aliphatic diol, a compound having an isocyanate group, and adipic acid, and even more preferably a polyaddition reaction product of 1,4-butanediol, diphenylmethane diisocyanate, and adipic acid. When such a polyurethane resin is used, it is easier to ensure the flexibility of the toner layer after fixing.

### <<Glass Transition Temperature Tg2 of Polyurethane Resin>>

The polyurethane resin contained in the toner preferably has a glass transition temperature Tg2 of less than 0° C. When the glass transition temperature Tg2 of the polyurethane resin contained in the toner is less than 0° C., the flexibility of the toner layer after fixing on a recording medium can be easily ensured.

### —Measurement of Glass Transition Temperature Tg2 of Polyurethane Resin—

The glass transition temperature Tg2 of the polyurethane resin can be measured, for example, by using a DSC system (differential scanning calorimeter) (“Q-200”, manufactured by TA Instruments). Specifically, first, about 5.0 mg of the polyurethane resin to be measured is charged into a sample container formed of aluminum, and the sample container is placed on a holder unit and set in an electric furnace. Next, in a nitrogen atmosphere, the polyurethane resin is heated from −50° C. to 150° C. at a temperature increase rate of 10° C./min (first temperature increase). Afterwards, the sample container is cooled from 150° C. to −50° C. at a temperature decrease rate of 10° C./min, and further heated to 150° C. at a temperature increase rate of 10° C./min (second temperature increase). During each of the first temperature increase and the second temperature increase, a DSC curve is measured by using a differential scanning calorimeter (“Q-200”, manufactured by TA Instruments). From the obtained DSC curve, the DSC curves at the first and second temperature increases are selected using an analysis program in the Q-200 system, and the glass transition temperatures according to the tangent method Tg1st and Tg2nd at the first and second temperature increases of the measured polyurethane resin are determined, and Tg2nd is employed as the glass transition temperature Tg2 of the measured polyurethane resin.

Preferably, the polyurethane resin contained in the toner is a polyaddition reaction product of an aliphatic diol and a compound having an isocyanate group and the glass transition temperature Tg2 is less than 0° C. When a toner including such a polyurethane resin is used, it is easier to ensure the flexibility of the toner layer after fixing.

### <<Weight Average Molecular Weight Mw of Polyurethane Resin>>

The polyurethane resin contained in the toner has a weight average molecular weight Mw of preferably 40,000 to 130,000, more preferably 40,000 to 110,000, and even more preferably 40,000 to 100,000. When the weight average molecular weight Mw of the polyurethane resin contained in the toner is 40,000 or more, there is no risk of an image after fixing on the recording medium being dissolved when the image is ironed, and when the weight average molecular weight Mw is 130,000 or less, other toner components and an adhesive can be easily melted and kneaded when the toner is produced. When a toner including a polyurethane resin having such a weight average molecular weight is used, it is easier to ensure the flexibility of the toner layer after fixing.

### —Measurement of Weight Average Molecular Weight Mw of Polyurethane Resin—

A weight average molecular weight Mw of the polyurethane resin can be obtained by measuring the molecular weight distribution of the tetrahydrofuran (THF) soluble portion using a gel permeation chromatography (GPC) measurement device. The GPC measurement device is not particularly limited and can be appropriately selected depending on the intended purpose. For example, a product name, GPC-150C (manufactured by Waters Corporation) or the like can be used.

A column used for measuring the weight average molecular weight is not particularly limited and can be appropriately selected depending on the intended purpose. Examples of the column include, but are not limited to, in expressing in product name, KF801 (a column for organic solvent based SEC (GPC)), KF802 (a column for organic solvent based SEC (GPC)), KF803 (a column for organic solvent based SEC (GPC)), KF804 (a column for organic solvent based SEC (GPC)), KF805 (a column for organic solvent based SEC (GPC)), KF806 (a column for organic solvent based SEC (GPC)), and KF807 (a column for organic solvent based SEC (GPC)) (all manufactured by Showa Denko K.K.).

A method for measuring the weight average molecular weight of the polyurethane resin is not particularly limited and can be appropriately selected depending on the intended purpose. For example, the method can be as follows.

Specifically, for example, a column is stabilized in a heat chamber at 40° C., and THF serving as a solvent passes at a flow rate of 1 mL per minute. Next, after thoroughly dissolving 0.05 g of a sample in 5 g of THF, the eluate is filtered through a pretreatment filter (for example, product name: CHROMATODISK, pore size: 0.45 μm, manufactured by Kurabo Industries Ltd.) to achieve the final sample concentration of 0.05% by mass to 0.6% by mass. After 50 μL to 200 μL of the THF sample solution obtained by adjusting the sample concentration is injected into the column and the THF-soluble fraction contained in the THF sample solution is separated, the fraction is converted into a molecular weight using a detector (for example, a differential refractive index (RI) detector (device name: GPC-150C, manufactured by Waters Corporation)) so that the weight average molecular weight (Mw) of the THF-soluble fraction contained in the THF sample solution can be measured.

The measurement of the weight average molecular weight Mw of the THF-soluble fraction contained in the sample calculates the molecular weight distribution of the sample from the relationship between the count number and the logarithmic value of a calibration curve prepared by using several types of monodispersed polystyrene standard samples.

For example, polystyrene manufactured by Pressure Chemical Co. or TOSOH CORPORATION having a molecular weight of 6×10², 2.1×10², 4×10², 1.75×10⁴, 5.1×10⁴, 1.1×10⁵, 3.9×10⁵, 8.6×10⁵, 2×10⁶, and 4.48×10⁶ is employed for a standard polystyrene sample for creating a calibration curve and at least about 10 standard polystyrene samples are preferably employed. A refractive index (RI) detector is preferably employed for the detector.

Commercially available polyurethane resin used in the toner is not particularly limited and can be appropriately selected depending on the intended purpose, and examples thereof include, but are not limited to, hot melt powder ECOFREEN POWDER (manufactured by ECOFREEN Co., Ltd.), T8175N (manufactured by DIC Covestro Polymer Co., Ltd.), and P22MBRNAT (manufactured by Nippon Miractoran Co., Ltd.).

### <Other Resins>

The toner may contain resins (“other resins”) other than the polyurethane resin. Examples of such resins include any conventionally known resins. Specific examples thereof include, but are not limited to, binder resins such as a styrene-based resin (a homopolymer or a copolymer containing styrene or a styrene substitute) such as styrene, poly-α-methylstyrene, a styrene-chlorostyrene copolymer, a styrene-propylene copolymer, a styrene-butadiene copolymer, a styrene-vinyl chloride copolymer, a styrene-vinyl acetate copolymer, a styrene-maleic acid copolymer, a styrene-acrylic ester copolymer, a styrene-methacrylic ester copolymer, a styrene-methyl α chloroacrylate copolymer, and a styrene-acrylonitrile-acrylic ester copolymer, an epoxy resin, a vinyl chloride resin, a rosin-modified maleic acid resin, a phenolic resin, a polyethylene resin, a polypropylene resin, a petroleum resin, a polyester resin, a ketone resin, an ethylene-ethyl acrylate copolymer, a xylene resin, and a polyvinyl butyrate resin. The method for producing such resins is not particularly limited, and bulk polymerization, solution polymerization, emulsion polymerization, suspension polymerization or the like may be employed.

The toner preferably contains a polyester resin as the other resins.

When the toner contains a polyester resin, a good electrostatic charge ability and low-temperature fixation can be achieved while a heat-resistant storage stability is maintained. Further, when a polyurethane resin and a polyester resin are combined, such resins tend to be incompatible with each other, and therefore, a sea-island structure tends to be formed in the cross section of the toner particle.

### <<Polyester Resin>>

The polyester resin that can be contained in the toner is preferably obtained by condensation polymerization of alcohol and carboxylic acid.

The alcohol may not be particularly limited and appropriately selected depending on the intended purpose, and examples thereof include, but are not limited to, glycols such as ethylene glycol, diethylene glycol, triethylene glycol, and propylene glycol, etherified bisphenols such as 1,4-bis(hydroxymethyl)cyclohexane and bisphenol A, monomers of other dihydric alcohols, and monomers of trihydric or higher polyhydric alcohols.

The carboxylic acid may not be particularly limited and appropriately selected depending on the intended purpose, and examples thereof include, but are not limited to, a bivalent organic acid monomer such as maleic acid, fumaric acid, phthalic acid, isophthalic acid, terephthalic acid, succinic acid, and malonic acid and a trivalent or higher multivalent carboxylic acid monomer such as 1,2,4-benzenetricarboxylic acid, 1,2,5-benzenetricarboxylic acid, 1,2,4-cyclohexanetricarboxylic acid, 1,2,4-naphthalenetricarboxylic acid, 1,2,5-hexanetricarboxylic acid, 1,3-dicarboxyl-2-methylenecarboxypropane, and 1,2,7,8-octanetetracarboxylic acid.

The softening temperature and the glass transition temperature of the polyester resin are both preferably 60° C. or higher. When the softening temperature and the glass transition temperature of the polyester resin are both 60° C. or higher, the heat-resistant storage stability of the toner image can be ensured.

The softening temperature and a glass transition temperature Tg3 of the polyester resin used are both preferably 60° C. or higher. When the softening temperature and the glass transition temperature of the polyester resin are both 60° C. or higher, the heat-resistant storage stability of the toner image is more easily ensured.

### —Method for Measuring Softening Temperature of Polyester Resin—

The softening temperature of the polyester resin can be measured, for example, using a flow tester (CFT-500D manufactured by Shimadzu Corporation). Specifically, while 1.0 g of a polyester resin sample is heated at a temperature increase rate of 6° C./min, the polyester resin sample is applied with 1.96 MPa of a load by a plunger and is extruded from a nozzle having 1.0 mm of the diameter and 1.0 mm of the length, the plunger depression amount of the flow tester is plotted with respect to the temperature, and the temperature at which deformation of the sample first occurs (the temperature at which the sample begins to deform as the sample changes from a solid state to a rubbery state) can be determined as the softening temperature by a flow tester.

### —Method for Measuring Glass Transition Temperature Tg3 of Polyester Resin—

The glass transition temperature Tg3 of the polyester resin can be measured, for example, by using the polyester resin for a sample to be measured in much the same manner as in the above-mentioned method for measuring the glass transition temperature Tg2 of the polyurethane resin.

### <Confirmation of Presence of Resin in Toner and Quantification>

Confirmation of the presence and the quantification of the resin contained in the toner can be suitably determined by a gas chromatograph mass spectrometer (GC-MS), nuclear magnetic resonance (NMR), or the like. Specifically, for example, the confirmation of the presence and the quantification can be carried out according to the following procedure, apparatus, and conditions.

### <<Component Analysis by GC-MS>>

### [Sample Preparation]

The toner or a coarsely pulverize product melt-kneaded with a toner component is dispersed in chloroform and stirred overnight to obtain a dispersion liquid. Then, such dispersion liquid is centrifuged and only the supernatant is collected. The collected supernatant is evaporated to dryness and the composition thereof is analyzed by a gas chromatograph mass spectrometer (GC-MS). An example of the measurement conditions by GC-MS is described below. The sample is a mixture obtained by dropping about 1 μL of a methylating agent (a 20% methanol solution of tetramethylammonium hydroxide: TMAH) onto about 1 mg of the sample.

### [Measurement Conditions]

Pyrolysis—Gas Chromatography Mass Spectrometer (Py-GCMS) Analyzer: QP2010 (manufactured by Shimadzu Corporation)
Heating furnace: Py2020D (manufactured by Frontier Labs, Inc.)
Heating temperature: 320° C.
Column: ULTRA ALLOY-5 (L=30 m, I.D=0.25 mm, Film=0.25 μm, manufactured by GL Sciences Inc.)
Column temperature: 50° C. (holding time: 1 min)->temperature increase (10° C./min)->340° C. (holding time: 7 min)
Split ratio: 1:100
Column flow rate: 1.0 ml/min
Ionization method: EI method (70 eV)
Measurement mode: Scan mode
Search data: NIST 20 MASS SPECTRAL LIB.

### <<Component Analysis by NMR>>

### [Sample Preparation]

The toner or a coarsely-pulverized melt-kneaded product of toner components is dispersed in chloroform and stirred overnight to obtain a dispersion liquid. Then, such dispersion liquid is centrifuged and only the supernatant is collected. The collected supernatant is evaporated to dryness and used as a sample for ¹H-NMR and ¹³C-NMR, and the composition is analyzed by NMR. An example of a method for preparing a sample for ¹H-NMR, a method for preparing a sample for ¹³C-NMR, and measurement conditions are described below.

(1) Method for preparing sample for ¹H-NMR

1 mL of d8-toluene (manufactured by Fujifilm Wako Pure Chemical Industries, Ltd.) is added to 100 mg of a sample, and the resultant sample is heated with a dryer to be dissolved to prepare a sample for ¹H-NMR.

(2) Method for preparing sample for ¹³C-NMR

1 mL of deuterated 1,2-dichlorotoluene (manufactured by Fujifilm Wako Pure Chemical Industries, Ltd.) is added to 100 mg of a sample, and the resultant sample is heated with a dryer to be dissolved to prepare a sample for ¹³C-NMR.

### [Measurement Conditions]

NMR device: ECX-500 (manufactured by JEOL Ltd.)
Measurement nuclear=¹H (500 MHz), measurement pulse file=single pulse dec. jxp (¹H), 45° C. pulse, 20,000 times accumulation, Relaxation Delay—4 seconds, Data points 32K, Offset 100 ppm, Observation width=250 ppm, Measurement temperature 70° C.
Measurement nuclear=¹³C (125 MHz), measurement pulse file=single pulse dec. jxp (¹³C), 45° C. pulse, 64 times accumulation, Relaxation Delay 5 seconds, data points 32K, Observation width=15 ppm, Measurement temperature 65° C.

### <Sea-Island Structure in SEM Image of Cross Section of Toner Particle>

The toner has a sea-island structure in a cross-sectional SEM image obtained by observing the cross section of a toner particle with a scanning electron microscope (SEM). The sea-island structure means a structure in which, when the continuous phase of one component contained in the toner is expressed as a “sea”, the other component is in the form of “islands” in the “sea”.

In the sea-island structure in the cross section of a toner particle, the “island” portion is a domain, and the “sea” portion is a matrix.

Among the components contained in the toner, components incompatible with matrix components forming the “sea” are domain components forming the “islands”. When an SEM image of a cross section of a toner particle includes a sea-island structure, the matrix components and the domain components are in an incompatible state, and thus, it is easier for the characteristics of each component to be exhibited, the toner image has an excellent electrostatic charge ability and heat-resistant storage stability to make the toner image fixed on a recording medium less likely to crack.

When a specific component is present in a toner at 50% by mass or more, such a component is the matrix forming the “sea”, and therefore, the matrix forming the “sea” of the sea-island structure in the SEM image of the cross section of the toner particle contains a polyurethane resin. Moreover, the domain forming the “island” preferably contains a resin, and more preferably contains a polyester resin. When the polyester resin is contained in the domain forming the “island”, the toner maintains an excellent electrostatic charge ability and heat-resistant storage stability, and is easily fixed at low temperatures.

### <<Observation of Sea-Island Structure in Cross Section of Toner Particle>>

The size and the number of domains being “island” portions in the cross section of a toner particle can be confirmed by observing a reflected electron image using a scanning electron microscope (SEM). In the sea-island structure of the toner, the presence of the domain being the island portion incompatible with the matrix being the sea portion can be confirmed by a difference in color between the domains forming the island portions and the matrix forming the sea portion. To provide contrast to facilitate the distinction between the island portions and the sea portion, the sea-island structure may be stained with ruthenium tetroxide, if desired. To facilitate cutting of the toner particle, the toner particle may be cut in a state where a toner sample is frozen with liquid nitrogen.

The following procedure and conditions are given in an example for observing a reflected electron image using a scanning electron microscope.

The sea-island structure in a cross-sectional SEM image of a toner particle can be observed similarly for both the toner particle and a particle of a coarsely-pulverized melt-kneaded product of toner components. Therefore, the toner particle or the particle of a coarsely-pulverized melt-kneaded product of toner components are embedded in an epoxy resin, frozen, and cut to expose a cross section, and then the sea-island structure can be observed using a scanning electron microscope (SU8230, manufactured by Hitachi, Ltd.) under the following conditions, for example. When the toner particle or the particle of the coarsely-pulverized melt-kneaded product of toner components is stained with ruthenium tetroxide, the non-stained parts are observed as dark parts, and thus, it is easy to distinguish the non-stained parts from the stained parts (light parts).

### [Observation Conditions]

Acceleration voltage: 5 kv
Emission current: 10 μA
Probe current: Norm
Condenser lens 1:5.0
W.D.: 8.0 mm
Observation mode: SE
Magnification: ×2,000 or ×5,000

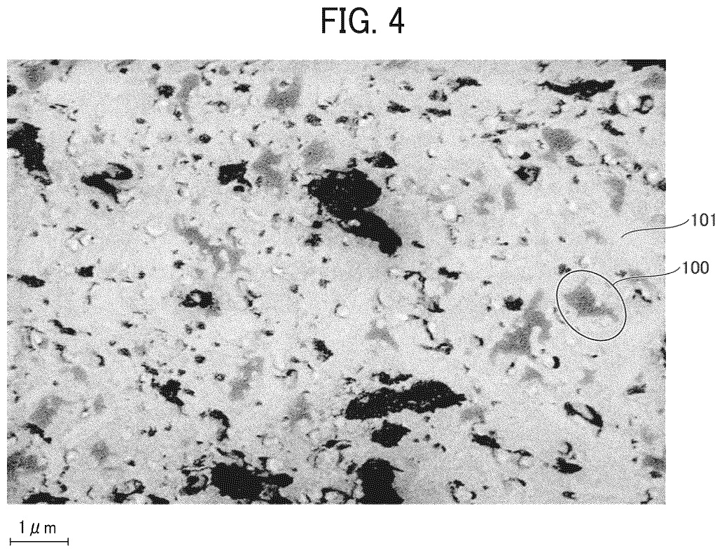

FIG. 4 is a cross-sectional SEM image of a particle of a coarsely-pulverized melt-kneaded product of toner components of a toner according to one embodiment of the present disclosure. In FIG. 4, a matrix 101 forming a sea portion and a domain 100 forming an island portion are present, and a sea-island structure can be confirmed. In FIG. 4, an island portion having a color intensity similar to that of the domain 100 is a domain having the same composition as the domain 100.

### <<Number of Domains in Cross Section of Toner Particle>>

In the SEM image of the cross section of the toner particle, three or more domains having an area of 0.1 μm² or more are preferably present on average per 100 μm², and five or more domains are more preferably present. In the sea-island structure of the cross section of the toner, when three or more domains having an area of 0.1 μm² or more are present on average per 100 μm², the toner has an excellent electrostatic charge ability and heat-resistant storage stability.

### —Measurement of Area and Number of Domains in Cross Section of Toner Particle—

From the SEM image of the cross section of a particle of the toner or the coarsely-pulverized melt-kneaded product of toner components, the average number of domains having an area of 0.1 μm² or more can be calculated per 100 μm² of the cross section of the toner particle.

The domain area in the SEM image of the cross section of the toner particle and the number of domains having an area of 0.1 μm² or more per 100 μm² can be determined, for example, by processing an SEM image of a particle cross section of a toner or a coarsely-pulverized melt-kneaded product of toner components using image processing software IMAGE-PRO Plus 5.1J (manufactured by MediaCybernetics). Specifically, SEM images of the particle cross sections of 100 particles of the toner or the coarsely-pulverized melt-kneaded product of toner components are binarized, for example, by IMAGE-PRO Plus5.1J (manufactured by MediaCybernetics), and the cross-sectional area of the particle of the toner or the coarsely-pulverized melt-kneaded product of toner components and the area of each domain that can be visually observed on the image can be evaluated from such binarized images, for example, using an image analyzing software such as A-ZOU-KUN (manufactured by Asahi Kasei Engineering Co., Ltd.).

In each toner particle or each particle of the coarsely-pulverized melt-kneaded product of toner components, after calculating the numbers of domains having an area of 0.1 μm² or more per 100 μm², such numbers are summed to be divided by the number, that is 100, of used particles of the toner used or the coarsely-pulverized melt-kneaded product of toner components used (the number of cross sections of toner particles or particles of coarsely-pulverized melt-kneaded product of toner components) to obtain the average number of domains having an area of 0.1 μm² or more per 100 μm² of the SEM image of the cross section of the toner particle of the toner.

### <Release Agent>

In the toner, a type of usable release agent is not particularly limited and can be appropriately selected depending on the intended purpose. One type may be used alone, or two or more types may be used in combination.

The release agent usable in the present disclosure is not particularly limited and can be appropriately selected depending on the intended purpose. Examples of the release agent include, but are not limited to, liquid paraffin, microcrystalline wax, natural paraffin, synthetic paraffin, polyolefin wax, and partial oxides of such compounds, or aliphatic hydrocarbons such as fluorides and chlorides, animal oils such as beef tallow and fish oil, vegetable oils such as palm oil, soybean oil, rapeseed oil, rice bran wax, and carnauba wax, higher aliphatic alcohols and higher fatty acids such as montan wax, fatty acid amides, fatty acid bisamides, metal soaps such as zinc stearate, calcium stearate, magnesium stearate, aluminum stearate, zinc oleate, zinc palmitate, magnesium palmitate, zinc myristate, zinc laurate, and zinc behenate, fatty acid esters, and polyvinylidene fluoride. Among such release agents, it is preferable to use a release agent containing at least an ester wax such as a fatty acid ester.

When the toner contains maleic acid-modified polyolefin having a polypropylene block in the main chain, when the content of the maleic acid-modified polyolefin is high, it is possible to separate the toner from the fixing roller or the fixing belt, and thus, a waste sheet jam may occur. However, such a problem can be resolved by adding an ester wax as the release agent. Further, the ester wax can be finely dispersed in the maleic acid-modified polyolefin having a polypropylene block in the main chain.

The content of the release agent in the toner is not particularly limited and may be appropriately selected depending on the intended purpose, but is preferably 0.1 to 8.0% by mass, and more preferably 1.0 to 6.0% by mass. When the content of the release agent is 0.1% by mass or more, the toner and the fixing roller or the fixing belt can be separated from each other during fixing to prevent waste sheet jams. When the content of the release agent is 8.0% by mass or less, the toner can be sufficiently fixed to the plastic film.

### <Colorant>

A colorant used in the toner is not particularly limited, and any commonly used colorant can be appropriately selected and used. Examples thereof include, but are not limited to, a black toner, a cyan toner, a magenta toner, a yellow toner, a white pigment, a green toner, and a blue toner.

The black toner is not particularly limited and can be appropriately selected depending on the intended purpose. Preferred examples include, but are not limited to, carbon black used alone, and a mixture of carbon black as a main component with copper phthalocyanine, in which the hue and brightness are adjusted.

The cyan toner is not particularly limited and can be appropriately selected depending on the intended purpose. Preferred examples include, but are not limited to, copper phthalocyanine being Pigment Blue 15:3, or a mixture of the colorant and aluminum phthalocyanine.

The magenta toner is not particularly limited and can be appropriately selected depending on the intended purpose. Pigment Red 53:1, Pigment Red 81, Pigment Red 122, and Pigment Red 269 can be used alone or in combination with each other.

The yellow toner is not particularly limited and can be appropriately selected depending on the intended purpose. Pigment Yellow 74, Pigment Yellow 155, Pigment Yellow 180, and Pigment Yellow 185 can be used alone or in combination with each other. It is preferable to use Pigment Yellow 185 alone or a mixture of Pigment Yellow 185 and Pigment Yellow 74 to obtain color saturation and storability.

The white pigment is not particularly limited and can be appropriately selected depending on the intended purpose. A material obtained by treating the surface of titanium dioxide with silicon, zirconia, aluminum, polyol, and the like can be used.

The green toner is not particularly limited and can be appropriately selected depending on the intended purpose. For example, Pigment Green 7 and the like can be used, but safety needs to be ensured.

The blue toner is not particularly limited, can be appropriately selected depending on the intended purpose, and examples thereof include, but are not limited to, Pigment Blue 15:1 and Pigment Violet 23.

When the toner according to an embodiment of the present disclosure is used as a base layer, by forming a known toner layer on the base layer, the known toner can also be fixed satisfactorily on a cloth medium having many uneven fibers. As used herein, the term “base layer” refers to a toner layer closest to a release support or a final recording medium.

The toner according to an embodiment of the present disclosure has rubber elasticity, so that a toner image using the toner is less likely to crack even when being pulled, folded, or washed. Even if a toner of another color is superimposed on the toner image, the color of the toner of the other color is not easily impaired. From such viewpoints, when the toner according to an embodiment of the present disclosure is used as a base layer, the colorant contained in the toner is preferably white, or the toner preferably does not contain a colorant. When the toner contains a white colorant, the toner will be white, and when the toner does not contain a colorant, the toner will be colorless.

The content of the colorant in the toner base particle is preferably 10% to 40% by mass. When the content of the colorant in the toner is 10% by mass or more, the concealability of the base can be sufficiently ensured, and particularly when the colorant is white, the color of the color toner layer formed as an image on the white toner layer is not impaired. When the content of the colorant in the toner is 40% by mass or less, a sufficient amount of resin can be contained in the toner, so that the image strength after image formation can be ensured.

### <Charge Control Agent>

The toner may contain a charge control agent.

The charge control agent is not particularly limited and can be appropriately selected depending on the intended purpose. Examples of the charge control agent include, but are not limited to, modified products by nigrosine, fatty acid metal salts, or the like, onium salts such as phosphonium salts and lake pigments thereof, triphenylmethane dyes and lake pigments thereof, metal salts of higher fatty acids; diorganotin oxides such as dibutyltin oxide, dioctyltin oxide, and dicyclohexyltin oxide; diorganotin borates such as dibutyltin borate, dioctyltin borate, and dicyclohexyltin borate, organic metal complexes, chelate compounds, monoazo metal complexes, acetylacetone metal complexes, aromatic hydroxycarboxylic acids, aromatic dicarboxylic acids-based metal complexes, and quaternary ammonium salts. Other examples include, but are not limited to, aromatic hydroxycarboxylic acids, aromatic mono- and polycarboxylic acids and metal salts, anhydrides, and esters thereof, and phenol derivatives such as bisphenol. Such charge control agents can be used alone or in combination of two or more types.

When such charge control agents are added internally to the toner for electrophotographic development, the content is not particularly limited and can be appropriately set depending on the intended purpose, but it is preferable to add 0.1% to 10% by mass with respect to the total amount of the binder resin. The charge control agent may color an object, and thus, it is preferable to select the charge control agent with a transparent color, as much as possible, except for a case of a black toner.

### <External Additives>

In the toner, inorganic fine particles and the like may be employed for an external additive.

The inorganic fine particles for an external additive employed in the present disclosure are not particularly limited and can be appropriately selected depending on the intended purpose. Examples of the inorganic fine particles include, but are not limited to, silica, alumina, titanium oxide, barium titanate, magnesium titanate, calcium titanate, strontium titanate, zinc oxide, silica sand, clay, mica, wollastonite, diatomaceous earth, chromium oxide, cerium oxide, bengara, antimony trioxide, magnesium oxide, zirconium oxide, barium sulfate, barium carbonate, calcium carbonate, silicon carbide, and silicon nitride. Among such inorganic fine particles, silica, alumina, and titanium oxide are preferred.

The inorganic fine particles may be subjected to surface treatment using a hydrophobicity treatment agent. The hydrophobicity treatment agent is not particularly limited and can be appropriately selected depending on the intended purpose. Examples of the preferred surface treatment agent include, but are not limited to, silane coupling agents, silylation agents, silane coupling agents having a fluorinated alkyl group, organic titanate-based coupling agents, and aluminum-based coupling agents. It is possible to also obtain a sufficient effect by using silicone oil as a hydrophobicity treatment agent.

The average diameter of the primary particles of the inorganic fine particles is not particularly limited and can be appropriately selected depending on the intended purpose, but is preferably 5 to 500 nm, and more preferably 5 to 200 nm. When the average diameter is 5 nm or more, the inorganic fine particles are prevented from aggregating, and the inorganic fine particles can be uniformly dispersed in the toner. When the average diameter is 500 nm or less, the heat-resistant storage stability can be improved due to the filler effect. The average particle size is a value obtained by directly determining the particle size from a picture obtained by a transmission electron microscope. It is preferable to observe at least 100 particles or more and use the average value of the major diameter.

### <Developer>

The toner can also be mixed with a carrier or the like to be used as a developer. In other words, the developer includes the toner according to one embodiment of the present disclosure, and may include other components such as a carrier, which are appropriately selected as necessary. When such a developer is employed, a base layer with an excellent fixability can be formed on the surface of a cloth.

The developer may be a one-component developer or a two-component developer. However, in used in a high-speed printer and the like responding to an increased information processing speed in recent years, a two-component developer is preferred in the viewpoint of a longer service life.

When the toner according to one embodiment of the present disclosure is used as a one-component developer, and even if the toner is consumed and resupplied, the particle size of the toner varies little, there is little filming of the toner on the developing roller, and the toner hardly fuses with a member such as a blade used to obtain a thin layer of the toner. Therefore, it is possible to obtain a good and stable developing property and image even when the developer is stirred during a long period of time in a developing device.

The toner according to one embodiment of the present disclosure can be mixed with a carrier to form a two-component developer, which can be used in a two-component development type electrophotographic image forming method. When the toner according to one embodiment of the present disclosure is used as the two-component developer, the particle size of the toner varies little even when the toner is consumed and resupplied over a long period of time. Therefore, a good and stable developing property and image can be obtained even when the toner is stirred during a long period of time in a developing device.

### <Magnetic Material>

When a two-component development method is used, the magnetic fine particles used in the magnetic carrier are not particularly limited and can be appropriately selected depending on the intended purpose. Examples of the magnetic fine particles include, but are not limited to, iron powder, magnetite, spinel ferrites such as gamma iron oxide, spinel ferrites containing one or more metals other than iron (Mn, Ni, Zn, Mg, Cu, or the like), magnetoplumbite-type ferrites such as barium ferrite, and particles of iron or alloys having an oxide layer on the surface. Among such magnetic fine particles, white magnetic fine particles are preferred in terms of color tone.

A shape of the magnetic fine particles may be in the form of any of granules, spheres, and needles.

In particular, when high magnetization is desired for the magnetic carrier, it is preferable to use ferromagnetic fine particles such as iron.

In consideration of chemical stability, it is preferable to use magnetite, spinel ferrite containing gamma iron oxide, and magnetoplumbite ferrite such as barium ferrite. Specifically, MFL-35S, MFL-35HS (manufactured by Powder Tech Co., Ltd.), DFC-400M, DFC-410M, SM-350NV (manufactured by Dowa Iron Powder Industries Co., Ltd.), or the like are preferred.

When the type and content of ferromagnetic fine particles (carrier) are selected, a resin carrier having a desired magnetization can be also used.

For example, the magnetic properties of the resin carrier are preferably such that the magnetization strength at 1,000 oersted is 30 to 150 emu/g.

Such a resin carrier can be produced by spraying a molten and kneaded product of magnetic fine particles and an insulating binder resin using a spray dryer, or a resin carrier in which magnetic fine particles (carrier) are dispersed in a condensation type binder can be produced by reacting and curing a monomer or prepolymer in an aqueous medium in the presence of magnetic fine particles.

The electrostatic charge ability can be controlled by adhering positively or negatively chargeable fine particles or conductive fine particles to the surface of the magnetic carrier, or by coating the surface with a resin.

Silicone resins, acrylic resins, epoxy resins, fluorine-based resins, or the like are employed for a surface coating material, and the coating material may include positively or negatively charged fine particles or conductive fine particles for coating. Of such resins, silicone resins and acrylic resins are preferred.

In the present disclosure, the mass ratio of the carrier in the two-component developer contained in a developing device is preferably 85% by mass or more and less than 98% by mass.

When the mass ratio of the carrier in the developer is 85% by mass or more, scattering of the toner from the developing device is unlikely to occur, and the occurrence of defective images can be reduced.

When the mass ratio of the carrier in the developer is less than 98% by mass, it is possible to suppress an excessive increase in the charge amount of the toner for electrophotographic development and a shortage in the supply amount of the toner for electrophotographic development, and thus, it is possible to reduce the occurrence of defective images due to a decrease in image density.

### <Fluidity Improver>

The present disclosure may include a fluidity improver as an additive. The fluidity improver is not particularly limited and can be appropriately selected depending on the intended purpose as long as the fluidity improver is subjected to surface treatment to increase the hydrophobicity and prevent the deterioration of flowability characteristics and charging characteristics even under high humidity. Examples of the fluidity improver include, but are not limited to, silane coupling agents, silylating agents, silane coupling agents having a fluorinated alkyl group, organic titanate-based coupling agents, aluminum-based coupling agents, silicone oil, and modified silicone oil.

The silica and titanium oxide used as the external additive treats the surface with such a fluidity improver and preferably is used as hydrophobic silica and hydrophobic titanium oxide.

### <Cleanability Improver>

The present disclosure may include a cleanability improver as an additive. The cleanability improver is not particularly limited as long as the cleanability improver can be added to the toner according to one embodiment of the present disclosure to remove the developer remaining on the electrostatic latent image bearer or the primary transfer medium after transfer, and can be appropriately selected depending on the intended purpose. Examples of the cleanability improver include, but are not limited to, fatty acid metal salts such as zinc stearate, calcium stearate, and stearic acid, polymer fine particles produced by soap-free emulsion polymerization, such as polymethyl methacrylate fine particles and polystyrene fine particles. The polymer particles preferably have a relatively narrow particle diameter distribution, and the volume average particle diameter is preferably 0.01 μm or more and 1 μm or less.

### <<Method of Manufacturing Toner>>

The method of manufacturing a toner used in the present disclosure is not particularly limited and can be appropriately selected depending on the intended purpose. An example of the method for manufacturing the toner will now be described.

The method for manufacturing the toner is preferably a melt-kneading pulverization method. This is because a step of cooling and rolling a molten and kneaded product of toner components is necessary to form the domains having the sea-island structure.

On the other hand, a polymerization method such as a dissolving and suspending method can be used in the present disclosure when a composition of a toner material and a step by which domains forming an island portion can be formed are adopted.

The size of the domain is determined by the compatibility between the domain material and the matrix material, and the drawing force applied during cooling and rolling of the molten and kneaded product. The compatibility between the domain material and the matrix material is determined according to the molecular weight and the composition of each material. Therefore, the easiest method for controlling the domain diameter is to use incompatible materials, determine in advance the relationship between the domain size and the rolling thickness, and reduce the thickness of the molten and kneaded product of the toner material to an appropriate thickness (preferably adjusted to 1 mm or less), as a result, a domain with a constant size can be obtained. In melting and kneading the toner material, it is preferable to keep the kneading intensity, the time, the number of times, and the temperature at such an extent that the toner has a sea-island structure of polyester and polyurethane.

As one embodiment, the method for manufacturing a toner can include a step of obtaining a binder resin mixture (mixing step), a step of obtaining a kneaded product of the mixture (melting and kneading step), a step of obtaining a solid product of the kneaded product (solidifying step), a step of obtaining a pulverized product of the solid product (fine-pulverizing step), and a step of classifying and collecting the pulverized product (classifying step).

### —Step of Obtaining Binder Resin Mixture (Mixing Step)—

First, a binder resin, a colorant, a release agent, and, if necessary, a charge control agent, and the like are mixed in a mixer to obtain a mixture (mixing step).

The mixer is not particularly limited and may be appropriately selected depending on the intended purpose. Examples of the mixer include, but are not limited to, a HENSCHEL MIXER (product name: FM20B, manufactured by Nippon Coke and Engineering Co., Ltd.) and a SUPER MIXER (SMV-20Ba, manufactured by Kawata Corporation).

### —Step of Obtaining Kneaded Product of Mixture (Melting and Kneading Step)—

Next, the resulting mixture is melt and kneaded using a thermal melting and kneading machine to obtain a kneaded product (melting and kneading step).

The thermal melting and kneading machine is not particularly limited and can be appropriately selected depending on the intended purpose. Examples thereof include, but are not limited to, by product name, PCM series twin screw extruder (manufactured by Ikegai Corporation), TEM type extruder (manufactured by Shibaura Machine Co., Ltd.), PCM Co-Kneader twin screw extruder (manufactured by Buss Corporation), NEEDEX open roll type continuous kneader (manufactured by Nippon Coke and Engineering Co., Ltd.), and batch kneader (WONDER KNEADER “WDS7-30” manufactured by Moriyama Corporation).

### —Step of Obtaining Solid Object of Kneaded Product (Solidifying Step)—

Next, the resultant kneaded product is cooled and solidified to obtain a solid object (solidifying step). The cooling method and the solidifying method are not particularly limited and can be appropriately selected depending on the intended purpose. An example of the method includes, but is not limited to, a method in which the molten and kneaded product is extruded through a die with 3 mm of a diameter using a feeder rudder to form strands, the strands are placed in a water tank containing water at 15° C. or less to be cooled and solidified, and the solidified strands are cut with a pelletizer to obtain toner pellets. The resultant toner pellets are the coarsely-pulverized melt-kneaded product of toner components.

### —Step of Obtaining Pulverized Solid Object (Finely Pulverizing Step)—

Next, the obtained solid object is finely pulverized to obtain a pulverized object (finely pulverizing step). The solid object can be pulverized using a known pulverizing method, such as a jet mill method in which the toner is contained in a high-speed air stream and the solid object is pulverized by the energy generated when the toner is collided with a collision plate, an inter-particle collision method in which toner particles are collided with each other in an air stream, or a mechanically pulverizing method in which the toner is supplied between a narrow gap and a rotor rotating at high speed and pulverized.

It is difficult to pulverize the toner at room temperature, and thus, it is preferable to put the toner pellets obtained in the solidifying step into a cooling machine, cool the toner pellets with liquid nitrogen, and pulverize the toner pellets with a mechanical pulverizer (RINREX MILL LX manufactured by Hosokawa Micron Corporation).

### —Step of Classifying and Collecting Pulverized Object (Classifying Step)—

The pulverized object is then classified to collect a pulverized object having a predetermined volume average particle diameter. As a result, a toner can be obtained (classifying step). A classifying method is not particularly limited and may be appropriately selected depending on the intended purpose. For example, any method can be appropriately used.

The toner according to one embodiment of the present disclosure may be produced by using a dissolving and suspending method. When the toner is produced by using the dissolving and suspending method, an oil phase in which a toner material such as a binder resin, a colorant, a release agent, and, if necessary, a charge control agent are dissolved or dispersed in an organic solvent is dispersed in an aqueous medium (aqueous phase) to react with the binder resin. This produces a dispersion liquid containing a dispersion (oil droplets) containing a prepolymer in which the toner material is emulsified or dispersed. Thereafter, the organic solvent is removed from the dispersion liquid, and the resulting mixture is filtered, washed, dried, and further, for example, classified as necessary to produce base particles of the toner. When the base particles obtained by the dissolving and suspending method are granulated, it is possible to obtain the toner according to one embodiment of the present disclosure.

The organic solvent is not particularly limited and can be appropriately selected depending on the intended purpose. However, an organic solvent having a boiling point of less than 150° C. is preferred in view of easily removing the organic solvent.

The organic solvent having a boiling point of less than 150° C. is not particularly limited and can be appropriately selected depending on the intended purpose. Examples thereof include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Such organic solvents may be used alone or in combination of two or more types.

Among such organic solvents, ethyl acetate, toluene, xylene, benzene, methylene chloride, 1,2-dichloroethane, chloroform, and carbon tetrachloride are preferable, and ethyl acetate are more preferable.

The aqueous medium is not particularly limited and can be appropriately selected depending on the intended purpose, and examples thereof include, but are not limited to, water, a solvent miscible with water, and a mixture thereof. Such aqueous media may be used alone or in combination of two or more types. Among such aqueous media, water is preferred.

The solvent miscible with water is not particularly limited and can be appropriately selected depending on the intended purpose, and examples thereof include, but are not limited to, alcohol, lower ketones, dimethylformamide, tetrahydrofuran, and cellosolve based solvents.

The alcohol is not particularly limited and can be appropriately selected depending on the intended purpose, and examples thereof include, but are not limited to, methanol, isopropanol, and ethylene glycol.

The lower ketones are not particularly limited and can be appropriately selected depending on the intended purpose, and examples thereof include, but are not limited to, acetone and methyl ethyl ketone.

A method of removing the organic solvent from the dispersion liquid is not particularly limited and can be appropriately selected depending on the intended purpose. Examples of the method include, but are not limited to, a method of gradually increasing the temperature of the entire reaction system to evaporate the organic solvent in the oil droplets, and a method of spraying the dispersion liquid into a dry atmosphere to remove the organic solvent in the oil droplets.

In the classification by the dissolving and suspending method, a fine particle portion may be removed in a liquid by using a cyclone, a decanter, or centrifugal separation.

Alternatively, a classification operation may be implemented after drying.

### (Toner Set)

A toner set according to an embodiment of the present disclosure refers to a set including a color toner containing a binder resin and a colorant, and the toner according to an embodiment of the present disclosure.

The color toner is not particularly limited and a known color toner may be appropriately selected depending on the intended purpose. The binder resin contained in the color toner is not particularly limited and can be appropriately selected depending on the intended purpose. For example, a binder resin similar to the binder resin contained in the toner according to one embodiment of the present disclosure, may be used. The colorant is not particularly limited and a known colorant can be appropriately selected depending on the intended purpose. For example, a colorant similar to the colorant contained in the toner according to one embodiment of the present disclosure, may be used.

When the above toner set is mounted in an image forming apparatus described below to form an image, an image is formed by using the toner according to one embodiment of the present disclosure. Thus, it is possible to form an image with taking advantage of a characteristic of the toner having an excellent fixability to a cloth.

### (Image Transfer Sheet)

An image transfer sheet according to an embodiment of the present disclosure refers to a sheet having a toner image formed with the toner according to an embodiment of the present disclosure on a release support. The sheet serving as the transfer medium for the toner image is not particularly limited as long as such a sheet is a sheet-like material on which an image is formed, and specific examples thereof include, but are not limited to, a release support using a flexible recording medium such as a cardboard, a postcard, roll paper, an envelope, ordinary paper, thin paper, coated paper or coated paper such as art paper, tracing paper, an OHP sheet, an OHP film, a resin film, from which the toner image can be released or a cloth from which the toner image can be released. From the viewpoint of releasability of the toner image, it is preferable that a layer containing at least one of a silicone component or a fluorine component is formed on a surface of a sheet serving as the transfer medium. Examples of the silicone component include, but are not limited to, silicone-based resins, and examples of the fluorine component include, but are not limited to, fluorine-based resins.

### (Toner Storage Unit)

A toner storage unit according to an embodiment of the present disclosure refers to a unit obtained by storing the toner according to an embodiment of the present disclosure in a unit having a function of storing the toner. Here, an aspect of the toner storage unit is not particularly limited and can be appropriately selected depending on the intended purpose. Examples of the toner storage unit include, but are not limited to, a toner storage container, a developing device, and a process cartridge.

The term toner storage container refers to a container in which the toner is stored.

It is noted that when the toner according to an embodiment of the present disclosure is used as a developer, the toner storage container may be referred to as a developer storage container.

The developer storage container is not particularly limited and can be appropriately selected from known containers. An example of the developer storage container may include, but is not limited to, an object including a container main body and a cap.

A size, a structure, a material, and the like of the container main body of the toner storage container and the developer storage container are not particularly limited and can be appropriately selected depending on the intended purpose.

A shape of the container main body of the developer storage container is not particularly limited and can be appropriately selected depending on the intended purpose, but it is preferable that the container main body is cylindrical in shape or the like and has a spirally formed uneven portion on an inner circumferential surface. When the container main body is rotated, it is possible to easily transfer the developer which is an agent to be contained therein to a discharge port side. It is more preferable that a part or all of the uneven portion is formed in a bellows shape. This allows the developer to move more easily toward the discharge port side.

Materials of the toner storage container and the developer storage container are not particularly limited and can be appropriately selected depending on the intended purpose. However, it is preferable that the material has a good dimensional accuracy, and examples of the material include, but are not limited to, resin materials such as a polyester resin, a polyethylene resin, a polypropylene resin, a polystyrene resin, a polyvinyl chloride resin, polyacrylic acid, a polycarbonate resin, an ABS resin, and a polyacetal resin.

The toner storage container and the developer storage container can be easily stored, transported, and the like, and have an excellent handling property, and therefore, can be attached to and detached from an image forming apparatus, a process cartridge, and the like, which will be described below, and used for replenishing the toner and the developer.

The developing device is a device including means used for storing and developing the toner.

The term process cartridge refers to a cartridge in which at least an electrostatic latent image bearer and a developing device are integrally formed, which stores the toner, and which is attachable to and detachable from the image forming apparatus. The process cartridge may further include at least one selected from a charging device, an exposure device, a cleaning device, and the like.

When the toner storage unit according to one embodiment of the present disclosure is mounted in the image forming apparatus according to one embodiment of the present disclosure to form an image, the image is formed by using the toner according to one embodiment of the present disclosure, so that the image can be formed by using the toner having an excellent fixability to a cloth.

### (Image Forming Method and Image Forming Apparatus)

An image forming apparatus according to an embodiment of the present disclosure includes an electrostatic latent image bearer, an electrostatic latent image forming device that forms an electrostatic latent image on the electrostatic latent image bearer, a developing device that develops the electrostatic latent image formed on the electrostatic latent image bearer with a developer including the toner according to an embodiment of the present disclosure, to form a toner image, a transfer device that transfers the toner image formed on the electrostatic latent image bearer onto a release support or onto a flexible recording medium having a surface roughness of 1 μm or more, and a fixing device that fixes the toner image transferred onto the release support or onto the flexible recording medium, and may further include other devices where necessary.

An image forming method according to an embodiment of the present disclosure includes forming an electrostatic latent image on an electrostatic latent image bearer, developing the electrostatic latent image formed on the electrostatic latent image bearer with a developer including the toner according to an embodiment of the present disclosure, to form a toner image, transferring the toner image formed on the electrostatic latent image bearer onto a release support or onto a flexible recording medium having a surface roughness of 1 μm or more, and fixing the toner image transferred onto the release support or onto the flexible recording medium, and the toner image is formed with the toner according to an embodiment of the present disclosure, and the method may include other processing where necessary.

The image forming method may be suitably performed by the image forming apparatus, the forming the electrostatic latent image may be suitably performed by the electrostatic latent image forming device, the developing may be suitably performed by the developing device, the transferring may be suitably performed by the transfer device, the fixing may be suitably performed by the fixing device, and the other processing may be suitably performed by the other devices.

### <Electrostatic Latent Image Bearer>

A structure, a size, and the like of the electrostatic latent image bearer are not particularly limited and can be appropriately selected from known electrostatic latent image bearers depending on the intended purpose.

A material of the electrostatic latent image bearer is not particularly limited and can be appropriately selected depending on the intended purpose. Examples of the material include, but are not limited to, an inorganic photoconductor such as amorphous silicon and selenium, and an organic photoconductor (OPC) such as polysilane and phthalopolymethine.

A shape of the electrostatic latent image bearer is not particularly limited and can be appropriately selected depending on the intended purpose, but a cylindrical shape is preferred. An outer diameter of the electrostatic latent image bearer having the cylindrical shape is not particularly limited and can be appropriately selected depending on the intended purpose. However, the outer diameter is preferably 3 mm or more and 100 mm or less, more preferably 5 mm or more and 50 mm or less, and further preferably 10 mm or more and 30 mm or less.

### <Electrostatic Latent Image Forming Device and Forming Electrostatic Latent Image>

The electrostatic latent image forming device in the image forming apparatus is not particularly limited as long as a means that forms an electrostatic latent image on an electrostatic latent image bearer is used, and can be appropriately selected depending on the intended purpose. For example, the electrostatic latent image forming device includes a charging device that uniformly charges a surface of the electrostatic latent image bearer, and an exposure device that exposes the surface of the electrostatic latent image bearer to light containing image information.

The forming the electrostatic latent image in the image forming method is forming an electrostatic latent image on an electrostatic latent image bearer, and includes charging the surface of the electrostatic latent image bearer, and exposing the charged surface of the electrostatic latent image bearer to light containing image information to form an electrostatic latent image.

The charging is not particular limited and can be appropriately performed depending on the intended purpose. For example, the charging may be performed by applying a voltage to the surface of the electrostatic latent image bearer by using a charging device.

The exposing is not particularly limited and can be appropriately selected depending on the intended purpose. For example, the exposing can be performed by exposing the surface of the electrostatic latent image bearer to light containing image information by using an exposure device.

The forming the electrostatic latent image is not particularly limited and can be appropriately selected depending on the intended purpose. For example, such forming can be performed by uniformly charging the surface of the electrostatic latent image bearer and then exposing the surface to light containing image information, and performed by an electrostatic latent image forming device.

### —Charging Device—

The charging device is not particularly limited and can be appropriately selected depending on the intended purpose. Examples thereof may include, but are not limited to, a contact charger including a conductive or semiconductive roll, a brush, a film, a rubber blade, or the like, and a non-contact charger utilizing corona discharge such as a corotron and a scorotron.

The charging device may be any form such as a form of a roller, a magnetic brush, and a fur brush, and can be selected according to a specification and an aspect of the image forming apparatus.

The charging device is preferably a charging device that is arranged in contact with or not in contact with the electrostatic latent image bearer and charges the surface of the electrostatic latent image bearer by applying DC and AC voltages in a superimposed manner.

Further, the charging device is preferably a charging device that charges the surface of the electrostatic latent image bearer by applying DC and AC voltages in a superimposed manner to a charging roller. The charging roller is preferably arranged in a non-contact manner close to the electrostatic latent image bearer by using a gap tape.

The charging device is not limited to the contact-type charging device, but it is preferable to use a contact-type charging device, from the viewpoint of obtaining an image forming apparatus in which an amount of ozone generated from the charging device is reduced.

### —Exposure Device—

The exposure device is not particularly limited and can be appropriately selected depending on the intended purpose as long as the exposure device can expose, to light containing information of the image to be formed, the surface of the electrostatic latent image bearer charged by the charging device. Examples thereof include, but are not limited to, various types of exposure devices such as a copying optical system, a rod lens array system, a laser optical system, and a liquid crystal shutter optical system exposure devices.

A light source used in the exposure device is not particularly limited and can be appropriately selected depending on the intended purpose. Examples thereof include, but are not limited to, a general light-emitting device such as a fluorescent lamp, a tungsten lamp, a halogen lamp, a mercury lamp, a sodium lamp, a light-emitting diode (LED), a semiconductor laser (LD), and an electroluminescence (EL).

To emit only light in a desired wavelength region, various types of filters can be used, such as a sharp cut filter, a band pass filter, a near infrared cut filter, a dichroic filter, an interference filter, and a color temperature conversion filter.

It is noted that a back-light method may be adopted in which the electrostatic latent image bearer is exposed in the form of an image from the back side.

### <Developing Device and Developing>

The developing device in the image forming apparatus is not particularly limited as long as the developing device can develop the electrostatic latent image formed on the electrostatic latent image bearer with a developer containing the toner according to an embodiment of the present disclosure to form a toner image, and can be appropriately selected depending on the intended purpose. The developing device may suitably include a developing device that contains a toner and can apply the toner to the electrostatic latent image in a contact or non-contact manner, for example, and may preferably be a developing device including a container with a toner.

The developing in the image forming method is a step of developing the electrostatic latent image formed on the electrostatic latent image bearer with a developer containing the toner according to an embodiment of the present disclosure to form a toner image, and a step of sequentially developing the electrostatic latent image with toners of a plurality of colors to form a toner image. For example, the formation of the toner image can be performed by developing the electrostatic latent image with the toner according to an embodiment of the present disclosure, and can be performed by the developing device.

In the developing device and the developing, the toner according to one embodiment of the present disclosure is used. Preferably, the toner image may be formed by using a developer containing not only the toner according to one embodiment of the present disclosure but also other components such as a carrier where necessary.

The developing device may be a developing device for single color applications or a developing device for multicolor applications. The developing device is preferably a developing device including a stirring device that frictionally stirs the toner to charge the toner, and a magnetic field generation unit fixed on the inside and the developing device including rotatable developer bearer carrying a developer including the toner on a surface.

For example, in the developing device, a toner and a carrier are mixed and stirred, and at this time, the toner is charged by a friction, and is maintained in an upright state on the surface of a rotating magnet roller, to form a magnetic brush. The magnet roller is placed near the electrostatic latent image bearer, and thus, a part of the toner forming the magnetic brush formed on the surface of the magnet roller moves to the surface of the electrostatic latent image bearer by electric attraction. As a result, the electrostatic latent image is developed by the toner, and a toner image is formed by the toner on the surface of the electrostatic latent image bearer.

The image forming apparatus can include a total of five developing devices, including a developing device for color toners (black, cyan, magenta, and yellow) and a developing device for the toner according to an embodiment of the present disclosure. The toner according to an embodiment of the present disclosure may be of any color, but is preferably colorless or white.

The toner used in the developing device may be a toner according to one embodiment of the present disclosure, partly or entirely, of the black, cyan, magenta, and yellow color toners.

### <Transfer Device and Transferring>

The transfer device in the image forming apparatus preferably includes a primary transfer unit that transfers a toner image onto an intermediate transfer body to form a composite transfer image, and a secondary transfer unit that transfers the composite transfer image onto a release support or onto a flexible recording medium having a surface roughness of 1 μm or more.

The intermediate transfer body is not particularly limited and can be appropriately selected from known transfer bodies depending on the intended purpose. A preferred example thereof includes a transfer belt.

The transferring in the image forming method is a step of transferring the toner image onto a release support or onto a flexible recording medium having a surface roughness of 1 μm or more. In a preferred aspect of the transferring, the toner image is primarily transferred onto the intermediate transfer body by using the intermediate transfer body, and then, the toner image is secondly transferred onto the release support or onto a flexible recording medium having a surface roughness of 1 μm or more.

In a more preferred aspect of the transferring, the transferring includes a primary transferring step of transferring the toner image onto the intermediate transfer body to form a composite transfer image by using a toner of two or more colors, preferably, a toner of full colors, and a secondary transferring step of transferring the composite transfer image onto the release support or onto a flexible recording medium having a surface roughness of 1 μm or more.

The transferring may be performed by charging the toner image onto the electrostatic latent image bearer by using a transfer charger and may be performed by the transfer device. It is preferable that the transfer device (the first transfer unit and the secondary transfer unit) includes at least a transfer device that releases and charges the toner image formed on the electrostatic latent image bearer onto a release support side or a flexible recording medium side having a surface roughness of 1 μm or more. The number of the transfer device(s) may be one, or two or more.

Examples of the transfer device include, but are not limited to, a corona transfer device using corona discharge, a transfer belt, a transfer roller, a pressure transfer roller, and an adhesive transfer device.

The release support is not particularly limited as long as the release support is a release support where an unfixed toner image after development can be transferred, and can be appropriately selected depending on the intended purpose. A recording medium having a layer containing at least one of a silicone component or a fluorine component formed on the surface is preferred. The recording medium usable for the release support is not particularly limited, and examples thereof include, but are not limited to, release paper and flexible media. Ordinary paper or a PET base for OHP sheets can be employed for the release paper. An example of a flexible medium having a surface roughness of 1 μm or more includes, but is not limited to, a cloth. Examples of the silicone component include, but are not limited to, silicone-based resins, and examples of the fluorine component include, but are not limited to, fluorine-based resins.

A typical flexible recording medium having a surface roughness of 1 μm or more is a cloth, and is not particularly limited as long as the flexible recording medium can transfer an unfixed image after development, and can be appropriately selected depending on the intended purpose. An example thereof includes, but is not limited to, a cloth formed of fibers, and specifically, woven fabric and nonwoven fabric.

A toner image with a predetermined thickness can be formed by forming a toner image with the toner according to an embodiment of the present disclosure on a release support, then further forming a toner image with the toner according to an embodiment of the present disclosure on the toner image formed on the release support, and repeating the operations of transferring and fixing the toner image. The thickness of the toner image is preferably from 50 to 150 μm, and more preferably from 50 to 100 μm. When the thickness of the toner image is 50 μm or more, the toner image is less likely to crack due to expansion and contraction, and when the thickness is 150 μm or less, the toner image is less likely to be hard, there is almost no discomfort due to the hardness of the image area when the toner image touches the skin, and toner offset is less likely to occur. The thickness of the toner image can be measured by taking an enlarged photograph of the cross section of the toner image using a microscope.

### <Fixing Device and Fixing>

The fixing device in the image forming apparatus is not particularly limited and can be appropriately selected depending on the intended purpose, but is preferably a known heating and pressing unit. Examples of the heating and pressing unit include, but are not limited to, a combination of a heating roller and a pressure roller, and a combination of a heating roller, a pressure roller, and an endless belt.

The fixing in the image forming method is a step of fixing the toner image transferred onto the release support or the flexible recording medium using the fixing device, and may be performed for each color developer each time the toner image is transferred onto the release support or the flexible recording medium, or may be performed simultaneously for each color developer in a stacked state at once.

The fixing device is preferably a heating and pressing unit including a heating element including a heat generating element, the release support in contact with the heating element, and a pressure member in pressure contact with the heating element via the release support, in which the heating and pressing unit can heat and fix the recording medium on which an unfixed image is formed by passing the recording medium between the film and the pressure member.

The heating temperature in the heating and pressing unit is not particularly limited and can be appropriately selected depending on the intended purpose, but is preferably 80° C. to 200° C.

The surface pressure in the heating and pressing unit is not particularly limited and can be appropriately selected depending on the intended purpose, but is preferably 10 N/cm² or more and 80 N/cm² or less.

In the present embodiment, depending on the intended purpose, a known optical fixing device may be used together with or instead of the fixing device, for example.

### <Other Devices and Other Steps>

In addition to the above-mentioned configuration, the image forming apparatus may include other devices appropriately selected as necessary, such as a static elimination device, a cleaning device, a recycling device, and a control device.

In addition to the above-mentioned configuration, the image forming method may have other steps appropriately selected as necessary, such as a static elimination step, a cleaning step, and a recycling step.

### <Static Elimination Device and Static Elimination Step>

The static elimination device is not particularly limited, as long as the static elimination device can apply a static elimination bias to the electrostatic latent image bearer. The static elimination device can be appropriately selected from known static elimination devices depending on the intended purpose, and a preferred example of the static elimination device includes, but is not limited to, a static elimination lamp.

The static elimination step is a step of applying a static elimination bias to the electrostatic latent image bearer to eliminate static electricity, and can be suitably performed by the static elimination device.

### <Cleaning Device and Cleaning Step>

The cleaning device is not particularly limited as long as the cleaning device can remove the toner remaining on the electrostatic latent image bearer. The cleaning device can be appropriately selected from known cleaners depending on the intended purpose, and preferred examples of the cleaning device include, but are not limited to, a magnetic brush cleaner, an electrostatic brush cleaner, a magnetic roller cleaner, a blade cleaner, a brush cleaner, and a web cleaner.

The cleaning step is a step of removing the toner remaining on the electrostatic latent image bearer, and can be suitably performed by the cleaning device.

The image forming apparatus can improve the cleanability when the image forming apparatus includes the cleaning device. That is, the fluidity of the toner is controlled by controlling the adhesive force between toners, and the cleanability can be improved. Further, by controlling the properties of the deteriorated toner, it is possible to maintain an excellent cleaning quality even under severe conditions such as a long life or high temperature and humidity. Further, the external additive can be sufficiently liberated from the toner on the electrostatic latent image bearer, and thus, a deposition layer (dam layer) of the external additive can be formed in a cleaning blade nip portion to achieve a high cleanability.

### <Recycling Device and Recycling Step>

The recycling device is not particularly limited and can be appropriately selected depending on the intended purpose. Examples of the recycling device include, but are not limited to, known conveyance means.

The recycling step is a step in which the toner removed in the cleaning step is recycled in the developing device, and can be suitably performed by the recycling device.

### <Control Device>

The control device can control the movement of each of the above-mentioned parts. The control device is not particularly limited and can be appropriately selected depending on the intended purpose as long as the control device can control the operation of each of the means described above. Examples of the control device include, but are not limited to, control equipment such as a sequencer and a computer.

The image forming apparatus can form an image using a toner according to one embodiment of the present disclosure, and can therefore provide images with an excellent fixability on flexible media such as a cloth and can reduce power consumption and stably provide a high-quality image.

The image forming method can form an image using a toner according to one embodiment of the present disclosure, and can therefore provide images with an excellent fixability on flexible media such as a cloth and can stably provide a high-quality image.

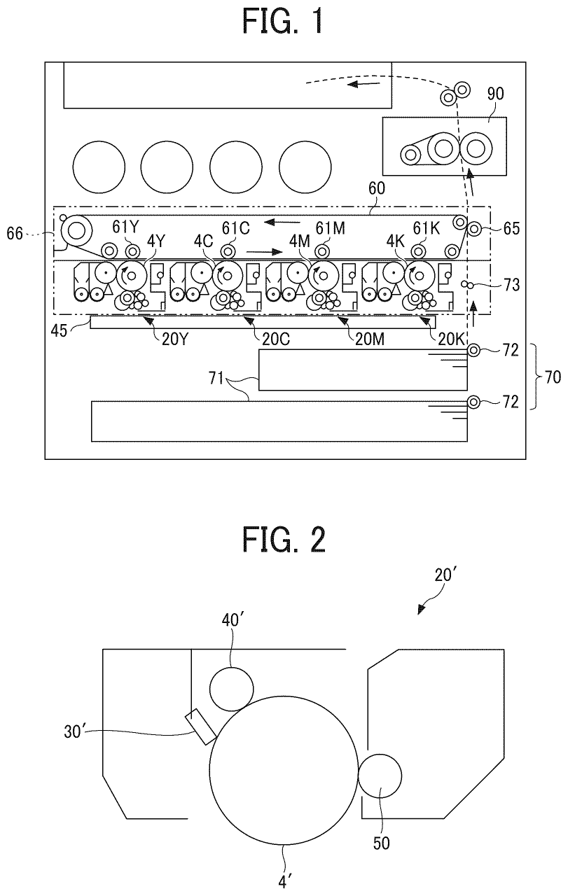

One example of the image forming apparatus will be described now with reference to FIG. 1. It is noted that the present disclosure is not limited to such embodiments in any way.

In the drawings, the same constituent components are denoted by the same reference numerals, and overlapping parts of the description may be omitted. Further, the number, a position, a shape, and the like of the following constituent components are not limited to the present embodiment, and may be the number, a position, a shape, and the like preferable for implementing the present disclosure.

FIG. 1 is a schematic diagram illustrating an image forming apparatus according to one embodiment of the present disclosure.

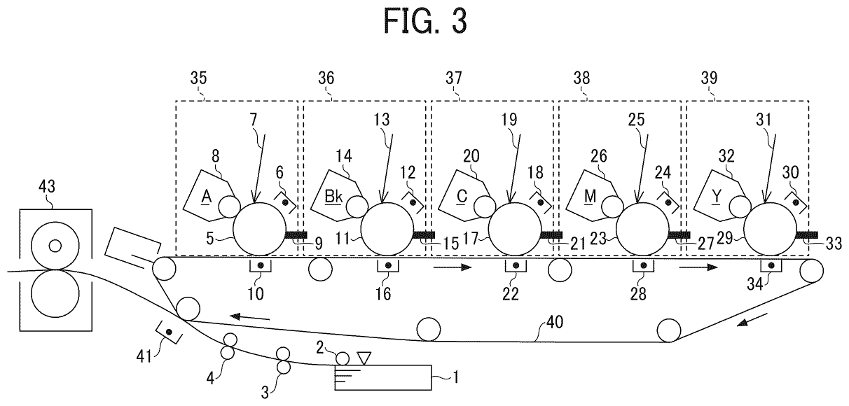

Although omitted in FIG. 1, the developing device for the toner according to an embodiment of the present disclosure is provided in the same manner as the developing devices for the toners of other colors (as in FIG. 3). For convenience, FIG. 1 will be described assuming that there are a toner image forming unit 20A according to an embodiment of the present disclosure, a photosensitive drum 4A which is an electrostatic latent image bearer, and a primary transfer roller 61A in FIG. 1.

The image forming apparatus illustrated in FIG. 1 is a tandem type image forming apparatus in which five toner image forming units 20Y, 20C, 20M, 20K, and 20A for yellow, cyan, magenta, black, and white toners are arranged in parallel, and the toner images of each color, yellow (Y), cyan (C), magenta (M), black (K), and white (A), formed by each toner image forming unit are superimposed to form a full-color image. The arrangement of the toner image forming unit for each color is not particularly limited.

The toner image forming units 20Y, 20C, 20M, 20K, and 20A include photoconductor drums 4Y, 4C, 4M, 4K, and 4A, respectively, which are rotated and driven as electrostatic latent image bearers. An exposure device 45 is provided which exposes each of the photoconductor drums 4Y, 4C, 4M, 4K, and 4A to laser light or LED light, based on image information of each color to form a latent image.

An intermediate transfer belt 60 serving as an intermediate transfer body is arranged to face each of the toner image forming units 20Y, 20C, 20M, 20K, and 20A with a surface of the intermediate transfer belt 60 being movable. Primary transfer rollers 61Y, 61C, 61M, 61K, and 61A are arranged at positions facing the respective photosensitive drums 4Y, 4C, 4M, 4K, and 4A via the intermediate transfer belt 60 to transfer the toner images of each color formed on the respective photosensitive drums 4Y, 4C, 4M, 4K, and 4A to the intermediate transfer belt 60.

The primary transfer rollers 61Y, 61C, 61M, 61K, and 61A sequentially transfer the toner image of each color formed by each of the toner image forming units 20Y, 20C, 20M, 20K, and 20A, respectively, described below onto the intermediate transfer belt 60, and form a full-color image by superimposing the image.

Downstream of the primary transfer rollers 61Y, 61C, 61M, 61K, and 61A with respect to the surface movement direction of the intermediate transfer belt 60, a secondary transfer device 65 is disposed which collectively transfers the toner images on the intermediate transfer belt 60 onto a transfer medium. Downstream of the secondary transfer device 65, a belt cleaning device 66 for removing a toner remaining on the surface of the intermediate transfer belt 60 is provided.

A sheet feed unit 70 including a sheet feed cassette 71, a sheet feed roller 72, and the like is provided at a lower part of the image forming apparatus, and feeds the transfer medium toward a registration roller 73. The registration roller 73 feeds the transfer medium toward a facing portion between the intermediate transfer belt 60 and the secondary transfer device 65 in accordance with the timing of the toner image formation. The full-color toner image on the intermediate transfer belt 60 is transferred onto a transfer medium by the secondary transfer device 65, and after being fixed by a fixing device 90, is discharged outside the apparatus.

Next, the toner image forming units 20Y, 20C, 20M, 20K, and 20A will be described.

Each of the toner image forming units 20Y, 20C, 20M, 20K, and 20A has almost the same configuration and operation except for the color of the toner contained therein, and thus, in the following explanation, the suffixes Y, C, M, K, and A for distinguishing colors will be omitted and the configuration and the operation of a toner image forming unit 20′ will be explained with reference to FIG. 2.

FIG. 2 is a schematic diagram illustrating a configuration of a main part in the image forming apparatus illustrated in FIG. 1.

Each means for performing the electrophotographic process, such as a charging device 40′, a developing device 50, and a cleaning device 30′ is arranged around a photosensitive drum 4′ in the toner image forming unit 20′, and a toner image of each color is formed on the photosensitive drum 4′ according to known operations. Such a toner image forming unit 20′ may be an integrally formed and be a process cartridge detachably attached to the main body of the image forming apparatus.

FIG. 3 is a schematic diagram illustrating a configuration of a main part of an image forming apparatus according to one embodiment of the present disclosure. It should be noted that a description for points similar to those in the above image forming apparatus will be omitted.

An image forming apparatus according to one embodiment of the present embodiment includes photoconductors (i.e., a photoconductor 5, a photoconductor 11, a photoconductor 17, a photoconductor 23, and a photoconductor 29) which are electrostatic latent image bearers, and includes chargers (i.e., a charger 6, a charger 12, a charger 18, a charger 24, and a charger 30) which are charging devices, developing devices (i.e., a developing device 8, a developing device 14, a developing device 20, a developing device 26, and a developing device 32), transfer devices (i.e., a transfer device 10, a transfer device 16, a transfer device 22, a transfer device 28, and a transfer device 34), and cleaning devices (i.e., a cleaning device 9, a cleaning device 15, a cleaning device 21, a cleaning device 27, and a cleaning device 33) around the respective photoconductors, and the photoconductors are irradiated with exposure light (i.e., exposure light 7, exposure light 13, exposure light 19, exposure light 25, and exposure light 31).

A developing unit for each color includes the photoconductor, the charger, the developing device, the cleaning device, and the like. A developing unit 35 uses the toner according to an embodiment of the present disclosure, a developing unit 36 uses a black toner, a developing unit 37 uses a cyan toner, a developing unit 38 uses a magenta toner, and a developing unit 39 uses a yellow toner to form an image, which is then transferred onto an intermediate transfer belt 40 to form an image. The image formed on the intermediate transfer belt 40 is transferred onto a transfer medium by a transfer device 41 and fixed by a fixing device 43. A sheet feed cassette 1 and a sheet feed roller 2 are disposed below the developing units and feed the transfer medium toward registration rollers 3 and 4. The registration rollers 3 and 4 feed the transfer medium toward the facing portion between the intermediate transfer belt 40 and the transfer device 41 in accordance with the timing of the toner image formation.

It is also preferable that the toner image according to an embodiment of the present disclosure is formed on the side closest to the transfer medium, and the transfer medium may be a release support or a flexible recording medium. The flexible recording medium preferably has a surface roughness of 1 μm or more, and an example thereof includes, but is not limited to, a cloth formed of fibers.

### (Thermal Transfer Fixing of Toner Image)

A method for thermally transferring and fixing the toner image formed on the release support to the final recording medium will be described.

The toner according to an embodiment of the present disclosure is used to form a toner image so that the toner image has a predetermined thickness, by repeatedly forming a toner image on the toner image formed on a release support by repeatedly further using a toner according to an embodiment of the present disclosure. The thickness of the toner image is preferably from 50 to 150 μm, and more preferably from 50 to 100 μm. When the thickness of the toner image is 50 μm or more, the toner image is less likely to crack due to expansion and contraction, and when the thickness is 150 μm or less, the toner image is less likely to be hard, there is almost no discomfort due to the hardness of the image area when the toner image touches the skin, and toner offset is less likely to occur. The thickness of the toner image can be measured by taking an enlarged photograph of the cross section of the toner image using a microscope.

Next, a final recording medium is placed on top of the toner image on the release support, followed by placing release paper thereon and then the toner image is applied with heat and pressure. For such an operation, a commercially available household iron or a commercial iron press (for example, a manual heat press machine PHP-MS233 manufactured by Piotec) can be used. Values of the temperature of the heat and the strength of the pressure to be applied can be selected according to the thermal properties of the toner, the type and thickness of the flexible recording medium, and the like. The release paper and the release support are then released to reveal the final recording medium with the toner image thermally transferred and fixed thereto. Thereafter, if necessary, release paper may be placed on the toner image, and heat and pressure may be applied again from above the release paper to further fix the toner image onto the final recording medium. The final recording medium is not particularly limited as long as the medium is a recording medium to which a toner image produced by the toner according to an embodiment of the present disclosure can be thermally transferred and fixed, and examples thereof include, but are not limited to, paper and a flexible recording medium. The flexible recording medium includes that having a surface roughness of 1 μm or more, and is particularly suitable for use on a cloth or the like formed of fibers.

### EXAMPLES

The present disclosure will be described more specifically below with reference to examples and comparative examples, but the present disclosure is not limited to such examples and comparative examples.

### Example for Manufacturing Toner 1

### —Raw Materials of Toner 1—

Polyurethane resin (ECOFREEN POWDER (manufactured by ECOFREEN), glass transition temperature Tg2: −29° C., weight average molecular weight Mw: 47,000, polyaddition reaction product of 1,4-butanediol, adipic acid, and diphenylmethane diisocyanate) 60% by mass
Polyester resin (RN-306SF, manufactured by Kao Corporation) 10% by mass
Wax dispersant (EXD-001, manufactured by Sanyo Chemical Co., Ltd.) 2.5% by mass
Ester wax (LW-13, manufactured by Sanyo Chemical Co., Ltd.) 2.5% by mass
Titanium oxide white pigment (PF-739, manufactured by Ishihara Sangyo Kaisha) 25% by mass

The above raw materials of the toner 1 were premixed using a HENSCHEL MIXER (FM20B, manufactured by Nippon Coke and Engineering Co., Ltd.), and then melted and kneaded at a set temperature of 90° C. in a batch kneader (WONDER KNEADER “WDS7-30”, manufactured by Moriyama Corporation). The obtained kneaded material was extruded through a die with a diameter of 3 mm using a feeder rudder to form strands, which were then placed in a water tank containing water at 15° C. or lower to be cooled and solidified, and the solidified strands were cut using a pelletizer to obtain a [toner pellet 1] with a diameter of 2 mm and a length of 2 mm. The [toner pellet 1] is a coarsely-pulverized melt-kneaded product of toner components.

Next, the [toner pellet 1] was placed in a cooling machine and cooled with liquid nitrogen, and then pulverized in a mechanical pulverizer (RINREX MILL LX, manufactured by Hosokawa Micron Corporation). The pulverized material discharged from the pulverizer was sieved through a 25 μm mesh. The part that did not pass through the 25 μm mesh was fed back into the pulverizer and sieved through a 25 μm mesh to obtain fine particles that passed through the 25 μm mesh. The fine particles that passed the 25 μm mesh were returned to room temperature, and then finely classified using an air classifier (EJ-LABO, manufactured by Matsubo Co., Ltd.) while appropriately adjusting the louver opening so that particles equal to or smaller than 5 μm constituted 10% by number or less to obtain a [toner base particle 1].

Next, 1.0 parts by mass of an additive 1 (HDK-2000, manufactured by Clariant Co., Ltd., substance name: silica) and 1.0 parts by mass of an additive 2 (H05TD manufactured by Clariant Co., Ltd., substance name: silica) was added to 100 parts by mass of the obtained [toner base particle 1] and stirred and mixed in a HENSCHEL MIXER to produce a [toner 1].

### Example for Manufacturing Toner 2

### —Raw Materials of Toner 2—

Polyurethane resin (ECOFREEN POWDER (manufactured by ECOFREEN), glass transition temperature Tg2: −29° C., weight average molecular weight Mw: 47000, polyaddition reaction product of 1,4-butanediol, adipic acid, and diphenylmethane diisocyanate) 40% by mass
Polyester resin (RN-306SF, manufactured by Kao Corporation) 30% by mass
Wax dispersant (EXD-001, manufactured by Sanyo Chemical Co., Ltd.) 2.5% by mass
Ester wax (LW-13, manufactured by Sanyo Chemical Co., Ltd.) 2.5% by mass
Titanium oxide white pigment (PF-739, manufactured by Ishihara Sangyo Kaisha) 25% by mass

A [toner base particle 2] was produced in the same manner as the [toner base particle 1], except that the raw materials of the toner 2 described above were used, and the [toner 2] was produced in the same manner as the [toner 1].

### Example for Manufacturing Toner 3

### Raw Materials of Toner 3—

Polyurethane resin (ECOFREEN POWDER (manufactured by ECOFREEN), glass transition temperature Tg2: −29° C., weight average molecular weight Mw: 47000, polyaddition reaction product of 1,4-butanediol, adipic acid, and diphenylmethane diisocyanate) 80% by mass
Polyester resin (RN-306SF, manufactured by Kao Corporation) 5% by mass
Wax dispersant (EXD-001, manufactured by Sanyo Chemical Co., Ltd.) 2.5% by mass
Ester wax (LW-13, manufactured by Sanyo Chemical Co., Ltd.) 2.5% by mass
Titanium oxide white pigment (PF-739, manufactured by Ishihara Sangyo Kaisha) 10% by mass

A [toner base particle 3] was produced in the same manner as the [toner base particle 1], except that the raw materials of the toner 3 described above were used, and the [toner 3] was produced in the same manner as the [toner 1].

### Example for Manufacturing Toner 4

### —Raw Materials of Toner 4—

Polyurethane resin (T8175N (manufactured by DIC Covestro Polymer), polyurethane elastomer, glass transition temperature Tg2: −36° C., weight average molecular weight Mw 12,7000, polyaddition reaction product of 1,4-butanediol, adipic acid, and diphenylmethane diisocyanate) 60% by mass
Polyester resin (RN-306SF, manufactured by Kao Corporation) 10% by mass
Wax dispersant (EXD-001, manufactured by Sanyo Chemical Co., Ltd.) 2.5% by mass
Ester wax (LW-13, manufactured by Sanyo Chemical Co., Ltd.) 2.5% by mass
Titanium oxide white pigment (PF-739, manufactured by Ishihara Sangyo Kaisha) 25% by mass

A [toner base particle 4] was produced in the same manner as the [toner base particle 1], except that the raw materials of the toner 4 described above were used, and the [toner 4] was produced in the same manner as the [toner 1].

### Example for Manufacturing Toner 5

A [toner base particle 5] was produced in the same manner as the [toner base particle 1], except that the raw materials of the toner 1 described above were used, and a [toner 5] was produced in the same manner as the [toner 1]. However, in the manufacturing process, a kneading step of melting and kneading was carried out at a set temperature of 90° C. in a batch kneader (WONDER KNEADER “WDS7-30” manufactured by Moriyama Corporation). A pellet forming step was carried out where the resulting kneaded material was then extruded through a 3 mm diameter die using a feeder rudder to form strands, which were then placed in a water tank containing water at 15° C. or lower to be cooled and solidified, and the solidified strands were cut using a pelletizer to form a [toner pellet] having 2 mm in diameter and 2 mm in length. The above steps from the kneading step to the pellet forming step were repeated twice to produce a [toner pellet 5]. This is a coarsely-pulverized melt-kneaded product of toner components of the toner 5.

### —Measurement of Glass Transition Temperature Tg2 of Polyurethane Resin—

The glass transition temperature Tg2 of the polyurethane resin used in the production of the [toner 1] to the [toner 5] was measured using a DSC system (differential scanning calorimeter) (“Q-200”, manufactured by TA Instruments). First, about 5.0 mg of the polyurethane resin to be measured was charged into a sample container formed of aluminum, and the sample container is placed on a holder unit and set in an electric furnace. Next, in a nitrogen atmosphere, the polyurethane resin was heated from −50° C. to 150° C. at a temperature increase rate of 10° C./min (first temperature increase). Afterwards, the sample was cooled from 150° C. to −50° C. at a temperature decrease rate of 10° C./min, and then, further heated to 150° C. at a temperature increase rate of 10° C./min (second temperature increase). During each of the first temperature increase and the second temperature increase, a DSC curve was measured by using a differential scanning calorimeter (“Q-200”, manufactured by TA Instruments). From the obtained DSC curves, the DSC curves at the first and second temperature increases are selected using an analysis program in the Q-200 system, and the measured glass transition temperatures according to the tangent method Tg1st and Tg2nd at the first and second temperature increases of the polyurethane resin were determined. The Tg2nd measured during the second temperature increase was taken as the measured glass transition temperature Tg2 of the polyurethane resin.

### <<Measurement of Weight Average Molecular Weight Mw of Polyurethane Resin>>

The weight average molecular weight of the polyurethane resin used in the toner was measured by the following method.

A column was stabilized in a heat chamber at 40° C., and THF serving as a solvent passes at a flow rate of 1 mL per minute. Next, after thoroughly dissolving 0.05 g of a sample of the polyurethane resin in 5 g of THF, the eluate was filtered through a pretreatment filter (product name: CHROMATODISK, pore size: 0.45 μm, manufactured by Kuraray Industries, Inc.) to adjust the final sample concentration to 0.05% by mass to 0.6% by mass. After 50 μL to 200 μL of the THF sample solution obtained by adjusting the sample concentration was injected into the column and the THF-soluble fraction contained in the THF sample solution was separated, the fraction was converted into a molecular weight using a detector (a differential refractive index (RI) detector (device name: GPC-150C, manufactured by Waters Corporation)) so that the weight average molecular weight (Mw) of the THF-soluble fraction contained in the THF sample solution was measured.

The measurement of the weight average molecular weight Mw of the THF-soluble fraction contained in the sample calculated the molecular weight distribution of the sample from the relationship between the count number and the logarithmic value of a calibration curve prepared by using several types of monodispersed polystyrene standard samples.

The standard polystyrene sample having a molecular weight of 6×10², 2.1×10², 4×10², 1.75×10⁴, 5.1×10⁴, 1.1×10⁵, 3.9×10⁵, 8.6×10⁵, 2×10⁶, and 4.48×10⁶ was employed for a standard polystyrene sample for preparing a calibration curve.

### <Measurement of Toner Glass Transition Temperature Tg1>

The glass transition temperature of the toner was measured by using a DSC system (differential scanning calorimeter) (“Q-200”, manufactured by TA Instruments). First, about 5.0 mg of the [toner 1] was charged into a sample container formed of aluminum, and the sample container was placed on a holder unit and set in an electric furnace. Next, in a nitrogen atmosphere, the polyurethane resin was heated from −50° C. to 150° C. at a temperature increase rate of 10° C./min. During the temperature increase, a DSC curve was measured by using a differential scanning calorimeter (“Q-200”, manufactured by TA Instruments). From the obtained DSC curves, the DSC curve during the temperature increase was selected by using the analysis program in the Q-200 system, to determine the glass transition temperature according to the tangent method of the [toner 1] to be tested at the temperature increase. The glass transition temperature according to the tangent method thus determined is the glass transition temperature Tg1 of the [toner 1]. The glass transition temperature Tg1 of each of the [toner 2] to the [toner 5] was measured in the same manner. The results are shown in Tables 1 and 2.

### <Measurement of Volume Average Particle Diameter of Toner>

The volume average particle diameter of the [toner 1] was measured using a particle diameter measurement device (“MULTISIZER III”, manufactured by Beckman Coulter) with an aperture diameter of 100 μm, and the volume average particle diameter was analyzed using analysis software (Beckman Coulter Multisizer 3 Version 3.51). Specifically 0.5 ml of a 10% by mass surfactant (alkylbenzene sulfonate, NEOGEN SC-A, manufactured by Daiichi Kogyo Seiyaku Co., Ltd.) was added to a 100 ml glass beaker, 0.5 g of the [toner 1] was added and stirred with a microspatula, and then 80 ml of ion-exchanged water was added to obtain a dispersion liquid. The resulting dispersion liquid was subjected to dispersion treatment for 10 minutes using an ultrasonic disperser (W-113MK-II, manufactured by Honda Electronics Co., Ltd.) to obtain a sample dispersion liquid of the [toner 1]. The particle diameter of the sample dispersion liquid of the [toner 1] was measured using the above-mentioned MULTISIZER III and ISOTON III (manufactured by Beckman Coulter, Inc.) as a measurement solution. The measurement was performed by dropping a sample dispersion liquid of the [toner 1] so that the concentration indicated by the device was within the range of 8±2%, so that there would be no error in the particle diameter and measurement reproducibility would be ensured. From the measurement of the particle diameter, the volume average particle diameter of the [toner 1] was evaluated. The volume average particle diameter of each of the [toner 2] to the [toner 5] was determined in the same manner. The result for each toner is shown in Tables 1 and 2.

### <Observation of Sea-island Structure in Cross Section of Toner Particle>

The presence or absence of the sea-island structure in the cross section of the toner particles of the [toner 1] to the [toner 5] was confirmed by observing, with a scanning electron microscope (SEM), the reflected electron image of the cross section obtained by freezing and cutting the particles of the coarsely-pulverized melt-kneaded product of toner components of each toner with liquid nitrogen. Specifically, the presence of a matrix being a sea portion and domains being island portions being incompatible with the matrix was confirmed by difference in color between the polyester resin and the polyurethane resin. To provide contrast and to facilitate the distinction between the island portions and the sea portion, particles of a coarsely-pulverized melt-kneaded product of toner components were stained with ruthenium tetroxide (substance name: ruthenium tetroxide, manufactured by TAAB). An SEM image of a cross section of a particle at a position at approximate half of the particle size of a coarsely-pulverized melt-kneaded product of toner components obtained after ruthenium staining were observed under the following conditions to determine whether a sea-island structure was present in each cross section of a particle. The procedure is described below.

Particles of a coarsely-pulverized melt-kneaded product of toner components of the [toner 1] to the [toner 5] were embedded in an epoxy resin and observed under the following conditions by using a scanning electron microscope (SU8230, manufactured by Hitachi, Ltd.). At this time, the unstained areas are observed as dark portions, and thus, can be distinguished from the stained areas (light portions).
Acceleration voltage: 5 kv
Emission current: 10 μA
Probe current: Norm
Condenser lens 1:5.0
W.D.: 8.0 mm
Observation mode: SE
Magnification: ×2,000 or ×5,000

FIG. 4 is a cross-sectional SEM image of particles of the coarsely-pulverized melt-kneaded product of toner components of the [toner 1]. In FIG. 4, a matrix 101 forming a sea portion and the domain 100 forming an island portion were observed, and thus, this illustrated that the cross-sectional SEM of the toner particles of the [toner 1] had a sea-island structure. In FIG. 4, a domain having a color intensity similar to that of the domain 100 is a domain having the same composition as the domain 100. The presence or absence of the sea-island structure was confirmed for the [toner 2] to the [toner 5] in the same manner. The results are shown in Tables 1 and 2.

### <Matrix and Domain Composition>

For a cross section of a coarsely-pulverized melt-kneaded product of toner components of a toner in which a sea-island structure was confirmed, the components contained in the matrix and domains were confirmed by component analysis using GC-MS and NMR.

### <<Component Analysis by GC-MS>>

### —Sample Preparation—

A coarsely-pulverized melt-kneaded product of toner components of each toner was dispersed in chloroform and stirred overnight to obtain a dispersion liquid. Then, such dispersion liquid was centrifuged and only the supernatant was collected. The collected supernatant was evaporated to dryness and the composition thereof was analyzed by a gas chromatograph mass spectrometer (GC-MS). The measurement conditions by GC-MS are described below. The sample was a mixture obtained by dropping about 1 μL of a methylating agent (a 20% methanol solution of tetramethylammonium hydroxide: TMAH) onto about 1 mg of the sample.

### —Measurement Conditions—

Pyrolysis—Gas Chromatography Mass Spectrometer (Py-GCMS) Analyzer: QP2010 (manufactured by Shimadzu Corporation)
Heating furnace: Py2020D (manufactured by Frontier Labs, Inc.)
Heating temperature: 320° C.
Column: ULTRA ALLOY-5 (L=30 m, I.D=0.25 mm, Film=0.25 μm, manufactured by GL Sciences Inc.)
Column temperature: 50° C. (holding time: 1 min)->temperature increase (10° C./min)->340° C. (holding time: 7 min)
Split ratio: 1:100
Column flow rate: 1.0 ml/min
Ionization method: EI method (70 eV)
Measurement mode: Scan mode
Search data: NIST 20 MASS SPECTRAL LIB.

### <<Component Analysis by NMR>>

### —Sample Preparation—

A coarsely-pulverized melt-kneaded product of toner components of each toner was dispersed in chloroform and stirred overnight to obtain a dispersion liquid. Then, such dispersion liquid was centrifuged and only the supernatant was collected. The collected supernatant was evaporated to dryness and used as a sample for ¹H-NMR and ¹³C-NMR, and the composition was analyzed by NMR. An example of a method for preparing a sample for ¹H-NMR, a method for preparing a sample for 13C-NMR, and measurement conditions are shown below.

(1) Method for preparing sample for ¹H-NMR

1 mL of d8-toluene (manufactured by Fujifilm Wako Pure Chemical Industries, Ltd.) was added to 100 mg of a sample, and the resultant sample was heated with a dryer to be dissolved to prepare a sample for ¹H-NMR.

(2) Method for preparing sample for ¹³C-NMR

1 mL of deuterated 1,2-dichlorotoluene (manufactured by Fujifilm Wako Pure Chemical Industries, Ltd.) was added to 100 mg of a sample, and the resultant sample was heated with a dryer to be dissolved to prepare a sample for 13C-NMR.

### —Measurement Conditions—

NMR device: ECX-500 (manufactured by JEOL Ltd.)
Measurement nuclear=¹H (500 MHz), measurement pulse file=single pulse dec. jxp (¹H), 45° C. pulse, 20,000 times accumulation, Relaxation Delay—4 seconds, Data points 32K, Offset 100 ppm, Observation width=250 ppm, Measurement temperature 70° C.
Measurement nuclear=¹³C (125 MHz), measurement pulse file=single pulse dec. jxp (¹³C), 45° C. pulse, 64 times accumulation, Relaxation Delay 5 seconds, data points 32K, Observation width=15 ppm, Measurement temperature 65° C.

In the above <<Component Analysis by GC-MS>> and <<Component Analysis by NMR>>, the resin component with the greater content was determined as the matrix, and the resin component with the smaller content was determined as the domain. The result for each toner is shown in Tables 1 and 2.

### (Manufacture of Two-Component Developer)

### <Preparation of Carrier>

Silicone resin (organo straight silicone) . . . 100 parts by mass
Toluene . . . 100 parts by mass
γ-(2-aminoethyl)aminopropyltrimethoxysilane . . . 5 parts by mass
Carbon black . . . 10 parts by mass

The above mixture was dispersed in a homomixer for 20 minutes to prepare a coating layer forming liquid.

Such coating layer forming liquid was applied to a core material formed of Mn ferrite particles having a weight average particle diameter of 35 μm so that a core material surface was coated with the coating layer forming liquid to form an average film thickness of 0.20 μm using a fluidized bed type coating device while controlling the temperature in the fluidized bed to 70° C., and then dried.

The obtained carrier was baked in an electric furnace at 180° C. for two hours to obtain a carrier A.

### <Preparation of Two-Component Developer>

Each of the prepared toners and the carrier A were uniformly mixed and charged for five minutes using a TURBULA mixer (manufactured by Willy A. Bachofen. AG (WAB)) at 48 rpm to prepare a two-component developer for each toner. The toner and the carrier were mixed at a mixing ratio such that the toner concentration in the initial developer was 7% by mass, in accordance with the toner concentration in the initial developer of the evaluation machine.

Using the obtained two-component developer, a toner image was formed on release paper serving as a release support, as described below, and then the toner image on the release paper was thermally transferred and fixed onto a cloth fabric, and each image was evaluated.

The evaluation method and conditions are as follows.

### <Preparation of Image for Evaluation>

### Example 1

(1) A two-component developer using the [toner 1] was set in the 5th station of a RICOH Pro C7200S (manufactured by Ricoh Co., Ltd.), and the developing and transfer conditions were adjusted using a process controller so that the toner adhesion amount was 1.0 mg/cm², and a solid image of the [toner 1] was transferred onto release paper (RICOPY PPC Paper Type SA, with a layer containing a silicone component on the surface of backing paper after a release sticker was removed, manufactured by Ricoh Co., Ltd.).

(2) Next, the toner image transferred onto the release paper was fixed.

(3) The above-mentioned operation of transferring a solid image of the [toner 1] onto the release paper and fixing the toner image transferred onto the release paper was repeated until the thickness of the toner image reached 71 μm. The thickness of the toner image was measured by taking an enlarged photograph of the cross section of the image using a microscope.

(4) A black 100% polyester cloth fabric was superimposed on the toner image on the release paper, and an iron having a temperature of 160° C. was strongly applied to the cloth fabric for 30 seconds to thermally transfer and fix the toner image to the cloth fabric, and thus prepare an image for evaluation.

### Example 2

A two-component developer was prepared in the same manner as in Example 1, except that the [toner 1] in Example 1 was changed to the [toner 3] and the thickness of the toner image was changed to 76 μm. An unfixed solid image was output and the toner image was fixed to release paper, and the toner image on the release paper was thermally transferred and fixed to a cloth fabric to prepare an image for evaluation.

### Example 3

A two-component developer was prepared in the same manner as in Example 1, except that the [toner 1] in Example 1 was changed to the [toner 4] and the thickness of the toner image was changed to 72 μm. An unfixed solid image was output and the toner image was fixed to release paper, and the toner image on the release paper was thermally transferred and fixed to a cloth fabric to prepare an image for evaluation.

### Comparative Example 1

A two-component developer was prepared in the same manner as in Example 1, except that the [toner 1] in Example 1 was changed to the [toner 2] and the thickness of the toner image was changed to 72 μm. An unfixed solid image was output and the toner image was fixed to release paper, and the toner image on the release paper was thermally transferred and fixed to a cloth fabric to prepare an image for evaluation.

### Comparative Example 2

A two-component developer was prepared in the same manner as in Example 1, except that the [toner 1] in Example 1 was changed to the [toner 5] and the thickness of the toner image was changed to 73 μm. An unfixed solid image was output and the toner image was fixed to release paper, and the toner image on the release paper was thermally transferred and fixed to a cloth fabric to prepare an image for evaluation.

### <Image Fastness Evaluation Method>

A fastness to washing test was conducted on the cloth fabrics to which the toner images were thermally transferred and fixed in Examples 1 to 3 and Comparative Examples 1 and 2 according to the test method in JIS 0844:2011, and each toner image thermally transferred and fixed on the cloth fabrics in Examples 1 to 3 and Comparative Examples 1 and 2 was evaluated according to the following criteria. The results are shown in Tables 1 and 2.

### [Evaluation Criteria]

A: JIS 0844 gray scale rank for color change and degradation 5, and no deterioration of image even after 10 repeated washings
B: JIS 0844 gray scale rank for color change and degradation 5, and part of the image cracks after 10 repeated washings
C: JIS 0844 gray scale rank for color change and degradation 4-3
D: JIS 0844 gray scale rank for color change and degradation 2-1

### <Concealability Evaluation Method>

The lightness L* of each toner image thermally transferred and fixed onto a black cloth fabric in Examples 1 to 3 and Comparative Examples 1 and 2 was measured using X-rite exact and evaluated according to the following criteria. The results are shown in Tables 1 and 2.

### [Evaluation Criteria]

A: L* is 85 or more
B: L* is 80 or more and less than 85
C: L* is less than 80

TABLE 1

| | Example 1 | Example 2 | Example 3 |
|---|---|---|---|
| Toner No. | 1 | 3 | 4 |
| Polyurethane resin content in | 60 | 80 | 60 |
| toner base particle (% by mass) | | | |
| Sea-island structure | Yes | Yes | Yes |
| Matrix and Domain Component | Matrix (sea portion) includes | | |
| | polyurethane resin. | | |
| | Domain (island portion) includes | | |
| | polyester resin. | | |
| Glass transition temperature | −10 | −18 | −13 |
| Tg1 of toner (° C.) | | | |
| Volume average particle diameter | 18 | 17 | 17 |
| of toner (μm) | | | |
| Layer including silicone component | Yes | Yes | Yes |
| on release paper | | | |
| Thickness of toner image (μm) | 71 | 76 | 72 |
| Image fastness | B | A | A |
| Concealability | A | A | A |

TABLE 2

| | Comparative | Comparative |
|---|---|---|
| | example 1 | example 2 |
| Toner No. | 2 | 5 |
| Polyurethane resin content in toner | 40 | 60 |
| base particle (% by mass) | | |
| Sea-island structure | Yes | No |
| Matrix and Domain Component | Matrix (sea portion) | No sea-island |
| | includes polyurethane | structure |
| | resin. | |
| | Domain (island portion) | |
| | includes polyester | |
| | resin. | |
| Glass transition temperature Tg1 | 4 | −21 |
| of toner (° C.) | | |
| Volume average particle diameter | 17 | 18 |
| of toner (μm) | | |
| Layer including silicone component | Yes | Yes |
| on release paper | | |
| Thickness of toner image (μm) | 72 | 73 |
| Image Fastness | D | B |
| Concealability | B | B |
| Remark (problem, etc.) | | Toner blocking occurs during storing at |
| | | ordinary temperature. |
| | | Toner scattering occurs during image |
| | | printing. |

In Examples 1 to 3, the toner had the glass transition temperature Tg1 of less than 0° C., the toner particles had a sea-island structure in the cross-sectional SEM images, and the content of polyurethane resin in the toner base particle was 50% by mass or more, so that the image fastness was rated as good, being “A” or “B”, and the concealability was rated as good, being “A” in all cases.

In Comparative Example 1, the content of polyurethane resin in the toner base particle was less than 50% by mass, and therefore, the flexibility of the toner layer after thermally transferring and fixing the toner image was low, the glass transition temperature Tg1 of the toner was 0° C. or higher, and the cross-sectional SEM image of the toner particle did not have a sea-island structure in which polyester was an island and polyurethane was a sea, so that the toner image did not stretch easily and was prone to cracking, and the image fastness was rated “D”. The concealability was rated as “B” in comparison with Examples 1 to 3, and was lower than Examples 1 to 3. In Comparative Example 2, the toner did not have a sea-island structure, and thus, serious problems arose in the electrostatic charge ability and heat-resistant storage stability of the toner.

From the above, it is demonstrated that a toner satisfying the configuration according to an embodiment of the present disclosure can provide a toner having an excellent fixability to a medium formed of flexible fibers such as a cloth, even immediately after the start of use, and also having an excellent flexibility.

Aspects of the present embodiment are as follows, for example.

### Aspect 1.

A toner including toner base particles comprising a polyurethane resin in an amount of 50% by mass or more and 80% by mass or less of the toner base particles, in which the toner has a glass transition temperature Tg1 of less than 0° C., and each particle of the toner has a sea-island structure in a cross-sectional image obtained by a scanning electron microscope of the particle.

### Aspect 2.

The toner according to Aspect 1, in which the polyurethane resin comprises a polyaddition reaction product of an aliphatic diol and a compound having an isocyanate group, and the polyurethane resin has a glass transition temperature Tg2 of less than 0° C.

### Aspect 3.

The toner according to Aspect 1 or 2, in which the polyurethane resin comprises a polyaddition reaction product of an aliphatic diol, a compound having an isocyanate group, and adipic acid, the aliphatic diol comprises 1,4-butanediol, the compound having an isocyanate group comprises diphenylmethane diisocyanate, and the polyurethane resin has a weight average molecular weight of the polyurethane resin is 40,000 to 130,000.

### Aspect 4.

The toner according to Aspect 1, 2, or 3, in which the toner is colorless or white.

### Aspect 5.

The toner according to Aspect 1, 2, 3, or 4, in which the toner base particles comprise a colorant in an amount of 10% to 40% by mass of the toner base particles.

### Aspect 6.

The toner according to Aspect 1, 2, 3, 4, or 5, in which the toner has a volume average particle diameter of 10 μm or more and 50 μm or less.

### Aspect 7.

A toner set including a color toner containing a binder resin and a colorant, and the toner according to Aspect 1, 2, 3, 4, 5, or 6.

### Aspect 8.

An image transfer sheet, including: a release support; and a toner image on the release support, formed with the toner according to Aspect 1, 2, 3, 4, 5, or 6.

### Aspect 9.

The image transfer sheet according to Aspect 8, in which the release support has, on a surface thereof, a layer containing at least one of a silicone component or a fluorine component.

### Aspect 10.

A toner storage unit including a container and the toner according to Aspect 1, 2, 3, 4, 5, or 6 stored in the container.

### Aspect 11.

An image forming apparatus including:
an electrostatic latent image bearer;
an electrostatic latent image forming device that forms an electrostatic latent image on the electrostatic latent image bearer;
a developing device that develops the electrostatic latent image formed on the electrostatic latent image bearer with a developer containing the toner according to Aspect 1, 2, 3, 4, 5, or 6 to form a toner image;
a transfer device that transfers the toner image formed on the electrostatic latent image bearer onto a release support or onto a flexible recording medium having a surface roughness of 1 μm or more; and
a fixing device that fixes the toner image transferred onto the release support or onto the flexible recording medium.

### Aspect 12.

An image forming method, including
forming an electrostatic latent image on an electrostatic latent image bearer,
developing the electrostatic latent image formed on the electrostatic latent image bearer with a developer containing the toner according to Aspect 1, 2, 3, 4, 5, or 6 to form a toner image,
transferring the toner image formed on the electrostatic latent image bearer onto a release support or onto a flexible recording medium having a surface roughness of 1 μm or more, and
fixing the toner image transferred onto the release support or onto the flexible recording medium.

### Aspect 13.

The image forming method according to Aspect 12, in which, after the transferring, the toner image is disposed closest to the release support or the flexible recording medium.

### Aspect 14.

The image forming method according to Aspect 12 or 13, in which the flexible recording medium is a cloth formed of fibers.

### Aspect 15.

The image forming method according to Aspect 12, 13, or 14, in which the toner image has a thickness of 50 to 150 μm.

According to the toner according to any one of Aspects 1 to 6, the toner set according to Aspect 7, the image transfer sheet according to Aspects 8 and 9, the toner storage unit according to Aspect 10, the image forming apparatus according to Aspect 11, and the image forming method according to any of Aspects 12 to 15, it is possible to solve the conventional various problems and achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The invention claimed is:

1. A toner comprising:
toner base particles comprising a polyurethane resin in an amount of 50% by mass or more and 80% by mass or less of the toner base particles,
wherein the toner has a glass transition temperature Tg1 of less than 0° C., and each particle of the toner has a sea-island structure in a cross-sectional image obtained by a scanning electron microscope of the particle.

2. The toner according to claim 1, wherein the polyurethane resin comprises a polyaddition reaction product of an aliphatic diol and a compound having an isocyanate group, and the polyurethane resin has a glass transition temperature Tg2 of less than 0° C.

3. The toner according to claim 1, wherein
the polyurethane resin comprises a polyaddition reaction product of an aliphatic diol, a compound having an isocyanate group, and adipic acid,
the aliphatic diol comprises 1,4-butanediol,
the compound having an isocyanate group comprises diphenylmethane diisocyanate, and
the polyurethane resin has a weight average molecular weight of 40,000 to 130,000.

4. The toner according to claim 1, wherein the toner is colorless or white.

5. The toner according to claim 1, wherein the toner base particles comprise a colorant in an amount of 10% to 40% by mass of the toner base particles.

6. The toner according to claim 1, wherein the toner has a volume average particle diameter of 10 μm or more and 50 μm or less.

7. A toner set comprising:
a color toner containing a binder resin and a colorant, and
the toner according to claim 1.

8. An image transfer sheet, comprising:
a release support; and
a toner image on the release support, formed with the toner according to claim 1.

9. The image transfer sheet according to claim 8, wherein the release support has, on a surface thereof, a layer containing at least one of a silicone component or a fluorine component.

10. A toner storage unit comprising:
a container; and
the toner according to claim 1 stored in the container.

11. An image forming apparatus comprising:
an electrostatic latent image bearer;
an electrostatic latent image forming device that forms an electrostatic latent image on the electrostatic latent image bearer;
a developing device that develops the electrostatic latent image formed on the electrostatic latent image bearer with a developer containing the toner according to claim 1 to form a toner image;
a transfer device that transfers the toner image formed on the electrostatic latent image bearer onto a release support or onto a flexible recording medium having a surface roughness of 1 μm or more; and
a fixing device that fixes the toner image transferred onto the release support or onto the flexible recording medium.

12. An image forming method, comprising:
forming an electrostatic latent image on an electrostatic latent image bearer;
developing the electrostatic latent image formed on the electrostatic latent image bearer with a developer containing the toner according to claim 1 to form a toner image;
transferring the toner image formed on the electrostatic latent image bearer onto a release support or onto a flexible recording medium having a surface roughness of 1 μm or more; and
fixing the toner image transferred onto the release support or onto the flexible recording medium.

13. The image forming method according to claim 12, wherein, after the transferring, the toner image is disposed closest to the release support or the flexible recording medium.

14. The image forming method according to claim 12, wherein the flexible recording medium is a cloth formed of fibers.

15. The image forming method according to claim 12, wherein the toner image has a thickness of 50 to 150 μm.
